(19) United States
(12) Patent Application Publication
(10) Pub. No.: US 2026/0205902 A1
(43) Pub. Date: Jul. 16, 2026

(54) Detecting Success and Failure of L1/L2-Triggered Mobility (LTM) Execution by User Equipment

(71) Applicant: Telefonaktiebolaget LM Ericsson (publ), Stockholm (SE)

(72) Inventors: Icaro Leonardo Da Silva, Solna (SE); Jens Bergqvist, Linköping (SE); Pontus Wallentin, Linköping (SE); Antonino Orsino, Kirkkonummi (FI)

(21) Appl. No.: 19/122,308

(22) PCT Filed: Dec. 7, 2023
(86) PCT No.: PCT/SE2023/051230

§ 371 Date: Apr. 18, 2025

Related U.S. Application Data
(60) Provisional application No. 63/430,682, filed on Dec. 7, 2022.

(51) Int. Cl. H04W 36/00; H04L 1/1812; H04W 36/08

(52) U.S. Cl. CPC H04W 36/0079; H04L 1/1812; H04W 36/08

(57) ABSTRACT

Embodiments include methods for a user equipment (UE) configured for L1/L2-triggered mobility (LTM) in a radio access network. Such methods include receiving configurations for one or more LTM candidate cells and an LTM cell switch command indicating a first one of the LTM candidate cells. Such methods include performing one or more of the following first operations in response to the LTM cell switch command: initiating a supervision timer for the LTM cell switch, initiating radio link monitoring in the first LTM candidate cell, initiating a random access procedure towards the first LTM candidate cell, transmitting an uplink message to the first LTM candidate cell, and monitoring a downlink control channel in the first LTM candidate cell. Such methods include determining that the LTM cell switch to the first LTM candidate cell was successful based on detecting one or more first conditions related to the one or more first operations.

### TECHNICAL FIELD

The present application relates generally to the field of wireless networks, and more specifically to improving mobility of user equipment (UEs) across multiple cells in a wireless network, specifically mobility based on layer-1 (L1) and/or layer-2 (L2) procedures that incur less delay than conventional layer-3 mobility procedures.

### BACKGROUND

Currently the fifth generation (5G) of cellular systems is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a fourth generation (4G) Long-Term Evolution (LTE) Evolved UMTS RAN (E-UTRAN). In such deployments, gNBs (e.g., 100, 150) can connect to one or more Mobility Management Entities (MMEs) in EPC (198) via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

NG RAN logical nodes (e.g., gNB 100) may include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

Seamless handovers are a key feature of 3GPP technologies. A UE is handed over from a source or serving cell, provided by a source node, to a target cell provided by a target node. Successful handovers ensure that the UE moves around in the coverage area of different cells without causing too many interruptions in the data transmission. However, handover can have various problems related to robustness. For example, a handover command (e.g., RRCReconfiguration message including a reconfigurationWithSync information element) is normally sent when the radio conditions for the UE are already quite bad and may not reach the UE before the UE's degraded connection with the source node/cell is dropped.

Upon receiving a handover command, a UE starts a timer T304 to monitor whether the handover is successful. Upon T304 expiry the UE considers the handover failed and performs recovery actions such as initiation of an RRC Re-establishment procedure including cell selection while another timer T311 is running. While T304 is running, the UE's radio resource control (RRC) layer triggers a random-access (RA) procedure with a target cell indicated in the reconfigurationWithSync IE. The handover is considered successful when the RA procedure is successfully completed before T304 expiry. The reconfiguration with sync procedure during handover is further defined in 3GPP TS 38.331 (v17.2.0) section 5.3.5.5.2.

A RACH-less handover was specified for LTE in 3GPP Rel-14. If the UE receives a handover command with a rach-Skip field, the UE should perform the handover to the target cell without performing a RA procedure. The UE initiates T304 in a similar manner as described above, but the handover is considered successful if the UE successfully receives certain information from the network via the target cell indicated in the handover command.

When the UE moves between the coverage areas of two cells, a serving cell change needs to be performed at some point. Currently, serving cell change is triggered by layer 3 (L3, e.g., RRC) measurements and involves RRC signaling to change PCell and/or PSCell (e.g., when dual connectivity is configured), as well as release/add SCells (e.g., when CA is configured). Currently, L3 inter-cell mobility involves complete layer 2 (L2) and layer 1 (L1, i.e., PHY) resets, leading to longer latency, increased signaling overhead, and longer interruptions than for intra-cell beam switching.

NR Rel-18 includes a Work Item on NR mobility enhancements, including in the feature of L1/L2 based inter-cell mobility, also referred to as L1/L2 triggered mobility (LTM) or lower layer-triggered mobility. This work item is further described in 3GPP document RP-213565. A goal of Rel-18 L1/L2 mobility (or LTM) enhancements is to facilitate serving cell change via L1/L2 signaling to reduce latency, signaling overhead, and interruptions associated with conventional L3 inter-cell mobility.

### SUMMARY

3GPP has agreed that a RACH-less procedure will be used for LTM execution, at least in some scenarios. Moreover, 3GPP has agreed that a supervision timer similar to T304 will be used for LTM execution, but there has been no agreement on how the LTM supervision timer will be used. For example, it is unclear what are the criteria for the UE to stop the supervision timer to prevent recovery actions when the LTM cell switch is successful, or what should be done to address the LTM cell switch failure case when the supervision timer expires.

Additionally, a UE may receive with an LTM cell switch command an indication to activate and/or switch to a Transmission Configuration Indicator (TCI) state of candidate (or target) cell indicated in the command (e.g., to change to a beam in the candidate cell). A changing of TCI state in intra-cell scenarios causes the UE to perform radio link monitoring using different reference signals (i.e., RLM-RS) than currently being monitored by the UE. Changing TCI state in this manner may lead to a radio link failure (RLF) due to radio problems in the candidate cell while the LTM supervision timer is running. However, it is unclear how the UE should handle a RLF that occurs in this scenario.

Accordingly, embodiments of the present disclosure address these and other problems, issues, and/or difficulties, thereby facilitating inter-cell beam management and L1/L2 mobility between cells in a RAN (e.g., NG-RAN).

Some embodiments of the present disclosure include methods (e.g., procedures) for a UE configured for L1/L2-triggered mobility (LTM) in a RAN.

These exemplary methods include receiving, from a RAN node via a serving cell, respective configurations for one or more LTM candidate cells. These exemplary methods also include receiving, from the RAN node via the serving cell, an LTM cell switch command indicating a first one of the LTM candidate cells. These exemplary methods also include performing one or more of the following first operations in response to the LTM cell switch command:
initiating a supervision timer for the LTM cell switch,
initiating radio link monitoring (RLM) in the first LTM candidate cell,
initiating a random access (RA) procedure towards the first LTM candidate cell,
transmitting an UL message to the first LTM candidate cell, and
monitoring a DL control channel in the first LTM candidate cell.

These exemplary methods also include determining that the LTM cell switch to the first LTM candidate cell was successful based on detecting one or more first conditions related to the first operations.

In some embodiments, the configuration for each LTM candidate cell include one or more of the following relating to LTM cell switch procedures to the LTM candidate cell:
an indication of whether to use a supervision timer;
an initial value for a supervision timer; and
an indication of whether a RA procedure is required.

In such embodiments, the first operations are performed in accordance with the configuration for the first LTM candidate cell.

In some embodiments, these exemplary methods also include performing one or more of the following second operations based on determining that the LTM cell switch to the first LTM candidate cell was successful: stopping the supervision timer, when running; and initiating RLM and/or beam failure detection (BFD) in the first LTM candidate cell as a new serving cell, when not already initiated.

In some of these embodiments, the first operations include initiating the supervision timer and initiating RLM in the first LTM candidate cell, and the first conditions include one of the following while the supervision timer is running:
detecting no radio link failure (RLF) based on the RLM;
receiving no out-of-sync (OOS) indications from UE lower layers based on the RLM; and
a running RLM-related timer does not expire.

In some variants of these embodiments, these exemplary methods include performs one or more of the following third operations based on determining that the LTM cell switch to the first LTM candidate cell was unsuccessful or has failed:
logging or storing information pertaining to the failed LTM cell switch;
reverting to a configuration associated with the serving cell;
initiating a radio resource control (RRC) reestablishment procedure; and
selecting a second one of the LTM candidate cells to perform another LTM cell switch.

In some further variants, determining that the LTM cell switch to the first LTM candidate cell was unsuccessful or has failed is based on detecting one or more of the following second conditions related to the first operations:
expiration of an RLM-related timer while the supervision timer is running; and
expiration of the supervision timer while the RLM-related timer is running.

In such variants, the third operations also include the following:
stopping the running supervision timer upon expiration of the RLM-related timer; and
stopping the running RLM-related timer and resetting any RLM-related counters, upon expiration of the supervision timer.

In other embodiments, the first operations include initiating the supervision timer and monitoring the DL control channel. In some variants, the first operations do not include initiating the RA procedure. The one or more first conditions include receiving, based on the monitoring, one or more first DL messages before expiration of the supervision timer. In some of these embodiments, the first operations also include transmitting the UL message, with the one or more first DL messages being responsive to the UL message.

In some of these embodiments, these exemplary methods also include determining that the LTM cell switch to the first LTM candidate cell was unsuccessful or has failed based on detecting any of the following second conditions related to the first operations:
receiving one or more second DL messages while the supervision timer is running; and
expiration of the supervision timer without receiving the one or more first DL messages.

In other embodiments, the first operations also include determining whether to initiate the RA procedure based on one or more of the following:
presence, absence, and/or value of a field or information element (IE) in the configuration for the first LTM candidate cell;
presence, absence, and/or value of a field or IE in the LTM cell switch command; and
whether the UE is time-aligned and/or UL synchronized with the first LTM candidate cell.

In such embodiments, the first operations include initiating the RA procedure selectively based on the determination whether to initiate. In some of these embodiments, when it is determined to initiate the RA procedure, one or more of the following applies:
the first operations include initiating the supervision timer but do not include initiating RLM; and
the first operations include transmitting the UL message, which is performed as part of RA procedure.

In some variants of these embodiments, the one or more first conditions include receiving a DL message responsive to the UL message, before expiration of the supervision timer.

Other embodiments include UEs (e.g., wireless devices) configured to perform operations corresponding to any of the exemplary methods described herein. Other embodiments also include non-transitory, computer-readable media storing computer-executable instructions that, when executed by processing circuitry, configure such UEs to perform operations corresponding to any of the exemplary methods described herein.

These and other embodiments described herein can provide various technical benefits and/or advantages. For example, embodiments can reduce and/or prevent undesired recovery actions. Due the conditions for considering an LTM cell switch procedure successful (causing UE to stop supervision timer), undesired recovery actions due to supervision timer expiration are prevented at the UE. This is especially an issue in the scenarios where LTM cell switch needs to be performed without a RA procedure (i.e., “RACH-less”). Preventing undesired recovery actions makes LTM RACH-less solutions more efficient, which reduces the delay to access an LTM candidate cell. Embodiments can facilitate predictable UE behavior in LTM execution failures and can reduce and/or eliminate ambiguity for UE actions in the event of LTM failures that are concurrent other failures such as radio link failure (RLF).

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level view of an exemplary 5G network architecture.

FIG. 2 shows an exemplary configuration of NR UP and CP protocol stacks.

FIGS. 3-4 illustrate various aspects of UE's operation during an exemplary radio link failure (RLF) procedure in LTE and NR.

FIGS. 5-6 show signaling diagrams that illustrates various embodiments of the present disclosure.

FIG. 7 shows an example inter-layer interaction in a UE in response to receiving a MAC-layer DL message from a network node serving an LTM candidate cell, according to various embodiments of the present disclosure.

FIG. 8 shows a signaling diagram that illustrates various embodiments of the present disclosure.

FIG. 9 shows an exemplary method (e.g., procedure) for a UE, according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, at least one of which is wireless, according to various embodiments of the present disclosure.

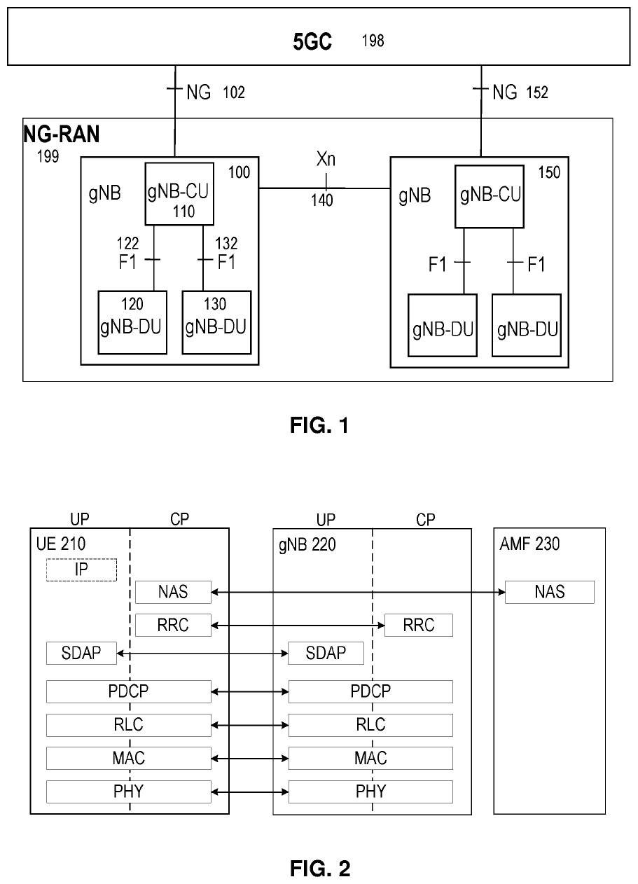

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

FIG. 2 shows an exemplary configuration of NR user plane (UP) and control plane (CP) protocol stacks between a UE (210), a gNB (220), and an AMF (230). Physical (PHY), Medium Access Control (MAC), Radio Link Control (RLC), and Packet Data Convergence Protocol (PDCP) layers between UE and gNB are common to UP and CP. PDCP provides ciphering/deciphering, integrity protection, sequence numbering, reordering, and duplicate detection for both CP and UP, as well as header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On CP side, the non-access stratum (NAS) layer between UE and AMF manages UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

LTE Rel-12 introduced dual connectivity (DC) whereby a UE in RRC_CONNECTED state can be connected to two network nodes simultaneously, thereby improving connection robustness and/or capacity. In LTE DC, these two network nodes are referred to as “Master eNB” (MeNB) and “Secondary eNB” (SeNB), or more generally as master node (MN) and secondary node (SN). More specifically, a UE is configured with a Master Cell Group (MCG) associated with the MN and a Secondary Cell Group (SCG) associated with the SN.

Each of these groups of serving cells include one MAC entity, a set of logical channels with associated RLC entities, a primary cell (PCell or PSCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG, respectively. In non-DC operation (e.g., CA), SpCell refers to the PCell. An SpCell is always activated and supports physical uplink control channel (PUCCH) transmission and contention-based random access (CBRA) by UEs.

The MeNB provides system information (SI) and terminates the control plane connection towards the UE and, as such, is the controlling node of the UE, including handovers to and from SeNBs. For example, the MeNB terminates the connection between the eNB and the MME for the UE. An SeNB provides additional radio resources (e.g., bearers) for radio resource bearers include MCG bearers, SCG bearers, and split bearers that have resources from both MCG and SCG. The reconfiguration, addition, and removal of SCells can be performed by RRC. When adding a new SCell, dedicated RRC signaling is used to send the UE all required SI of the SCell, such that UEs need not acquire SI directly from the SCell broadcast. In addition, either or both of the MCG and the SCG can include multiple cells working in carrier aggregation (CA).

3GPP TR 38.804 (v14.0.0) describes various exemplary DC scenarios or configurations in which the MN and SN can apply NR, LTE, or both. The following terminology is used to describe these exemplary DC scenarios or configurations:
DC: LTE DC (i.e., both MN and SN employ LTE, as discussed above);
EN-DC: LTE-NR DC where MN (eNB) employs LTE and SN (gNB) employs NR, and both are connected to EPC.
NGEN-DC: LTE-NR dual connectivity where a UE is connected to one ng-eNB that acts as a MN and one gNB that acts as a SN. The ng-eNB is connected to the 5GC and the gNB is connected to the ng-eNB via the Xn interface.
NE-DC: LTE-NR dual connectivity where a UE is connected to one gNB that acts as a MN and one ng-eNB that acts as a SN. The gNB is connected to 5GC and the ng-eNB is connected to the gNB via the Xn interface.
NR-DC (or NR-NR DC): both MN and SN employ NR.
MR-DC (multi-RAT DC): a generalization of the Intra-E-UTRA Dual Connectivity (DC) described in 3GPP TS 36.300 (v16.3.0), where a multiple Rx/Tx UE may be configured to utilize resources provided by two different nodes connected via non-ideal backhaul, one providing E-UTRA access and the other one providing NR access. One node acts as the MN and the other as the SN. The MN and SN are connected via a network interface and at least the MN is connected to the core network. EN-DC, NE-DC, and NGEN-DC are different example cases of MR-DC.

Seamless mobility is a key feature of 3GPP radio access technologies (RATs). In general, a network configures a UE to perform and report RRM measurements to assist network-controlled mobility decisions, such as for handover from a serving cell to a neighbor cell while the UE is in RRC_CONNECTED state. Seamless handovers ensure that the UE moves around in the coverage area of different cells without causing too many interruptions in data transmission.

The network can configure a UE in RRC_CONNECTED state to perform and report RRM measurements that assist network-controlled mobility decisions such as UE handover between cells, SN change, etc. The UE may lose coverage in its current serving cell (e.g., PCell in DC) and attempt handover to a target cell. Similarly, a UE in DC may lose coverage in its current PSCell and attempt an SN change. Other events may trigger other mobility-related procedures. An RLF procedure is typically triggered in the UE when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell (i.e., SpCell) and uses that information to decide whether the UE is in-sync (IS) or out-of-sync (OOS) with respect to that serving cell. In LTE, a UE performs RLM by measuring downlink reference signals (e.g., CRS) in RRC_CONNECTED state. If RLM (i.e., by L1/PHY) indicates number of consecutive OOS conditions to the UE RRC layer, then RRC starts a radio link failure (RLF) procedure and declares RLF after expiry of a timer (e.g., T310). The L1 RLM procedure involves comparing the estimated CRS measurements to some target block error rates (BLERs), called Qout and Qin. In particular, Qout and Qin correspond to BLER of hypothetical PDCCH/PCIFCH transmissions from the serving cell, with exemplary values of 10% and 2%, respectively. In NR, the network can define the RS type (e.g., CSI-RS and/or SSB), exact resources to be monitored, and even the BLER target for IS and OOS indications.

As briefly mentioned above, NR networks also provide coverage via beams. In general, a downlink (DL, i.e., network to UE) beam is a coverage area of a network-transmitted reference signal (RS) that may be measured or monitored by a UE. To support beam management, a UE can be configured with a Channel State Information (CSI) measurement configuration, which instructs the UE to monitor CSI-RS and to send various CSI reports to the RAN (e.g., NG-RAN). For example, the RAN indicates an explicit list of CSI resources to be monitored by the UE for each type of CSI report the UE is configured to send. Similar techniques can be used for beam management based on synchronization signal/PBCH block (SSB) RS transmitted by the network.

3GPP Rel-17 includes an inter-cell beam management feature wherein the UE can have multiple active transmission configuration indicator (TCI) states, including one associated with the physical cell identity (PCI) of its serving cell and up to M other TCI states associated with PCIs of other cells. For example, the different PCIs can represent different transmission reception points (TRPs). For each of the N additional TCI states, the UE can be configured with CSI resources (or resource sets) to monitor for inter-PCI (or inter-cell) beam management.

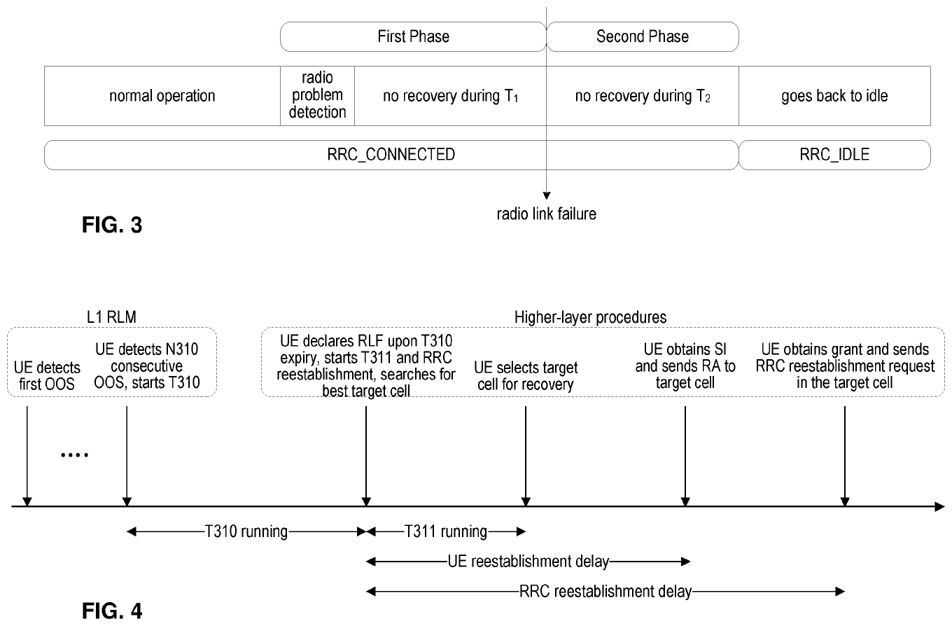

FIG. 3 shows a high-level timing diagram illustrating the two phases of an RLF procedure in LTE and NR. The first phase starts upon radio problem detection and leads to radio link failure detection after no recovery is made during a period T1. The second phase starts upon RLF detection or handover failure and ends with the UE returning to RRC_IDLE if no recovery is made during a period T2.

FIG. 4 shows a more detailed version of the UE's operations during an exemplary RLF procedure, such as for LTE or NR. In this example, the UE detects N310 consecutive OOS conditions during L1 RLM procedures, as discussed above, and then initiates timer T310. Subsequent operations are performed by higher layers (e.g., RRC). After expiry of T310, the UE starts T311 and RRC reestablishment, searching for the best target cell. After selecting a target cell for reestablishment, the UE obtains system information (SI) for the target cell and performs a random access (e.g., via RACH). The duration after T310 expiry until this point can be considered the UE's reestablishment delay. Ultimately, the UE obtains access to the target cell and sends an RRC Reestablishment Request message to the target cell. The duration after T310 expiry until this point can be considered the total RRC reestablishment delay. If the UE does not successfully reestablish in a target cell before expiration of T311, the UE enters RRC_IDLE and releases its connection to the network.

For NR-DC and NGEN-DC, T310 is used for both PCell/MCG and PSCell/SCG. For LTE-DC and NE-DC (i.e., where SN is eNB), T313 is used for PSCell/SCG. The UE reads the timer values from system information (SI) broadcast in the UE's SpCell. Alternatively, the network can configure the UE with UE-specific values of the timers and constants via dedicated RRC signaling (i.e., specific values sent to specific UEs via respective messages).

During preparation for handover of a UE to a target node, the source node sends the current UE configuration to the target node in the HANDOVER REQUEST message. The target node prepares a target configuration for the UE based on the current configuration and the capabilities of the target node and the UE. The target node sends the target configuration to the source node in a HANDOVER REQUEST ACKNOWLEDGE message, which the source node encapsulates in an RRCReconfiguration message to the UE. As a streamlined option, the target configuration can be signalled as a “delta-configuration” including only the differences from the UE's current configuration in the source cell.

Upon receiving a handover command, a UE starts a timer T304 to monitor whether the handover is successful. Upon T304 expiry the UE considers the handover failed and performs recovery actions such as initiation of an RRC Re-establishment procedure including cell selection while timer T311 is running (e.g., in a similar manner as the RLF procedure shown in FIG. 4). While T304 is running, the UE's RRC layer triggers the UE's MAC layer to perform a RA procedure with a target cell indicated in the reconfigurationWithSync IE. The handover is considered successful when the MAC layer completes the RA procedure successfully before T304 expiry. For Contention Based RA (CBRA), the reception of msg4 for contention resolution indicates success. For Contention Free RA (CFRA), the RA is considered successful when the UE receives a RA Response (RAR) in a MAC subPDU with a RA Preamble identifier corresponding to the PREAMBLE_INDEX for the preamble that the UE previously transmitted during the CBRA. The reconfiguration with sync procedure during handover is further defined in 3GPP TS 38.331 (v17.2.0) section 5.3.5.5.2.

A RACH-less handover was specified for LTE in 3GPP Rel-14. If the UE receives a handover command with a rach-Skip field, the UE should perform the handover to the target cell without performing a RA procedure. More specifically, the UE does not transmit RA msg1 (PRACH preamble) nor receive msg2 (RAR), but instead uses an UL grant to access the target cell for the transmission of a msg3 on the Physical Uplink Shared Chanell (PUSCH).

The UE initiates T304 in a similar manner as described above, but the handover is considered successful if the UE successfully receives certain information from the network via the target cell indicated in the handover command. In particular, success occurs when the UE receives a PDCCH transmission addressed to its cell radio network temporary identifier (C-RNTI) and a subsequent PDSCH transmission (indicated by the PDCCH) including a UE Contention Resolution Identity MAC control element.

As described above, layer 3 (L3, e.g., RRC) measurements trigger serving cell change, which involves RRC signaling to change PCell and/or PSCell (e.g., when dual connectivity is configured), as well as release/add SCells (e.g., when CA is configured). Currently, L3 inter-cell mobility involves complete layer 2 (L2) and layer 1 (L1, i.e., PHY) resets, leading to longer latency, increased signaling overhead, and longer interruptions than for intra-cell beam switching.

NR Rel-18 includes a Work Item on NR mobility enhancements, including in the feature of L1/L2 based inter-cell mobility, also referred to as L1/L2 triggered mobility (LTM) or lower layer-triggered mobility. This work item is further described in 3GPP document RP-213565. Some specific goals of this Work Item include:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

The proposed dynamic switch mechanism among candidate serving cells based on L1/L2 signaling is intended to reduce latency, signaling overhead, and interruptions associated with conventional L3 inter-cell mobility.

A basic principle of LTM is that the UE is pre-configured, by the network, with an RRC configuration per LTM candidate target cell. Each of these RRC configurations is also referred to as a LTM candidate target cell configuration and may be an RRCReconfiguration message or one or more IEs/fields/parameters (e.g., CellGroupConfig) that could be included in such a message. The UE performs measurements on these candidate LTM candidate target cells and transmits corresponding measurement reports to the network. The network then triggers UE execution of LTM cell switch by transmitting a lower layer message (e.g., MAC CE, DCI) to the UE, which then switches to the indicated LTM candidate target cell and connects to the cell (which then becomes the target cell).

At the 3GPP RAN2 #119-e and RAN2 #119bis-e meetings, there were multiple agreements made on L1/L2-triggered mobility related to the invention, and among these are the following:
RAN2 to use “LTM” as term for the L1/L2-triggered mobility.
Use the term “cell switch” for the procedure of triggering change of cells via the LTM feature.
RAN2 assumes that both RACH-based (CFRA, CBRA) and RACH-less procedures for L1 L2 mobility switch may be supported. RACH-less if the UE doesn't need to acquire TA during the cell switch. RAN2 understands that the feasibility of RACH-less may depend on RAN1, and expect that RAN1 is working on this.
For further study (FFS) if the MAC CE can indicate TCI state(s) (or other beam info) to activate for the target Cell(s), dep on RAN1 progress.

The following was agreed at the subsequent 3GPP RAN2 #120 meeting:
The MAC CE agreed to carry LTM related information for cell switch is used for LTM triggering of the cell switch.
LTM cell switch is supervised by a timer.
UE arrival in the target cell need to be indicated (somehow).

To summarize, 3GPP has agreed that a RACH-less procedure will be used for LTM execution, at least in some scenarios, and that a supervision timer similar to T304 will be used for LTM execution. However, there has been no agreement on how the LTM supervision timer will be used. For example, it is unclear what are the criteria for the UE to stop the supervision timer to prevent recovery actions when the LTM cell switch is successful, or what should be done to address the LTM cell switch failure case when the supervision timer expires.

Additionally, a UE may receive with an LTM cell switch command an indication to activate and/or switch to a TCI state of candidate (or target) cell indicated in the command (e.g., to change to a beam in the candidate cell). A changing of TCI state in intra-cell scenarios causes the UE to perform radio link monitoring using different reference signals (i.e., RLM-RS) than currently being monitored by the UE. Changing TCI state in this manner may lead to a radio link failure (RLF) due to radio problems in the candidate cell problems, e.g., start of timer T310 due to the number of OOS indications being above N310 counter. Such RLFs may occur while the LTM supervision timer is running, since the UE may re-start RLM in the candidate cell after receiving the LTM cell switch command. However, it is unclear how the UE should handle a RLF (or similar RLM problem) that occurs while the LTM supervision timer is running.

Embodiments of the present disclosure address these and other problems, difficulties, and/or issues by providing flexible and efficient techniques for a UE to determine whether a procedure for LTM cell switch (also referred to as “LTM execution”) is successful or has failed. Some embodiments involve the UE using an LTM supervision timer. In particular, the UE starts a supervision timer in response to the reception of an LTM cell switch command via the UE's current serving cell (e.g., PCell or PSCell). The UE monitors a control channel of a candidate cell (e.g., PDCCH according to a TCI state ID indicated in the LTM cell switch command) indicated in the LTM cell switch command. When the UE receives a DL message via the monitored control channel, the UE considers the LTM cell switch procedure successful, stops the supervision timer, and performs other actions accordingly in the candidate cell, such as initiating RLM.

On the other hand, when the supervision timer expires before the UE receives the DL message via the candidate cell, the UE determines that the LTM cell switch procedure failed and performs other actions accordingly, such as initiation of an RRC Re-establishment procedure (including cell selection while timer T311 is running), selection of a different candidate cell for a second LTM cell switch procedure (i.e., previously configured by the network before the UE started the failed LTM cell switch procedure), and/or logging of failure information related to the failed LTM cell switch procedure for later reporting to the network.

Various embodiments include different formats of the DL message for which the UE monitors in the candidate cell, such as PDCCH transmission with the UE's C-RNTI assigned for the candidate cell, a MAC CE received in the candidate cell in response to a UE UL message to the candidate cell during LTM execution, etc. In other embodiments, the UE may receive the DL message in the candidate cell either in response to the UE UL message transmitted in the candidate cell or merely after (e.g., in response to) reception of the LTM cell switch command in the source cell without an intervening UE UL message.

In some embodiments, the UE initiates the supervision timer only when the LTM cell switch requires a RA procedure. Otherwise, the UE using a different method (i.e., without supervision timer) to determine whether the LTM cell switch procedure is successful or has failed.

In other embodiments, the UE does not use a supervision timer in any scenario. In these embodiments, the UE starts RLM in response to reception of an LTM cell switch command and determines that LTM execution is successful when the UE has not detected RLF within a short duration after reception of the LTM cell switch command. In contrast, the UE determines that LTM execution procedure has failed when the UE detects RLF within the short duration after the reception of the LTM cell switch command.

In other embodiments, the UE may employ the LTM supervision timer together with RLM. In these embodiments, the UE starts RLM and the LTM supervision timer in response to reception of an LTM cell switch command. The UE determines that LTM execution is successful when no RLM-related failure (e.g., OOS indications, RLF upon N310 consecutive OOS indications, expiry of timer T310) is detected while the supervision timer is running. In contrast, the UE determines that LTM execution procedure has failed when the UE detects an RLM-related failure while the supervision timer is running. Note that LTM execution success/failure is determined in these embodiments without the need for a DL message from the candidate cell.

Embodiments can provide various benefits and/or advantages. For example, embodiments can reduce and/or prevent undesired recovery actions. Due the disclosed criteria for considering an LTM cell switch procedure successful (causing UE to stop supervision timer), undesired recovery actions due to supervision timer expiration are prevented at the UE. This is especially an issue in the scenarios where LTM cell switch needs to be performed without a RA procedure, which is not specified for NR. Preventing undesired recovery actions makes the RACH-less solutions for LTM possible and efficient, which reduces the delay to access the candidate cell in LTM execution. In addition, embodiments also result in predictable UE behavior in LTM execution failure scenarios.

Additionally, embodiments can reduce and/or eliminate ambiguity for UE actions in the event of multiple concurrent failures. In the RACH-less LTM execution, reception of a TCI state indication (or an indication enabling the UE to determine a TCI state ID in the LTM candidate target cell to be activated) can lead to RLF due to radio problems while the supervision timer is running, as the UE may re-start RLM in the candidate cell after receiving the LTM cell switch command. Embodiments can prevent this occurrence by restricting only one failure mechanism to trigger at any given time, such that UE action is quite clear when a failure is detected by one mechanism (e.g., RLF) while another mechanism is pending (e.g., LTM supervision timer is running).

In the present disclosure, the following terms may be used interchangeably: “L1/L2 based inter-cell mobility” (as used in the 3GPP Work Item), “L1/L2-triggered mobility”, “LTM”, “L1/L2 mobility,” “L1-mobility,” “L1 based mobility,” “L1/L2-centric inter-cell mobility,” “L1/L2 inter-cell mobility,” “inter-cell beam management,” and “inter-DU L1/L2 based inter-cell mobility”. These terms refer to a scenario in which a UE receives lower layer (i.e., below RRC, such as MAC or PHY) signaling from a network indicating for the UE to change of its serving cell (e.g., PCell) from a source cell to a target cell. Exemplary lower layer signaling includes L1 DL control information (DCI) and L2 MAC control element (CE). Compared to conventional RRC signaling, lower layer signaling reduces processing time and interruption time during mobility and may also increase mobility robustness since the network can respond more quickly to changes in the UE's channel conditions.

In the present disclosure, the term “LTM candidate target cell” refers to a non-serving cell configured for a UE, to which the UE can perform an L1/L2 inter-cell mobility operation upon reception of lower layer signaling instructing the UE to do so. The terms “candidate cell,” “candidate,” “LTM candidate”, “mobility candidate,” “non-serving cell,” and “additional cell” may be used interchangeably with “LTM candidate target cell.” The UE may perform and/or report measurements (e.g., CSI measurements) on such a cell so that the network may make an informed decision about which beam (e.g., TCI state) and/or cell the UE is to be switched to by LTM execution. An LTM candidate target cell may be a primary cell candidate (e.g., for PCell or PSCell) or an SCell candidate (e.g., MCG SCell).

In the present disclosure, the term “LTM cell switch procedure” refers to the process of a UE changing its cell from a source cell to an LTM candidate target cell using L1/L2-triggered mobility. Moreover, “LTM cell switch procedure” may also be referred to as “dynamic switch”, “LTM switch”, “(LTM) cell switch”, “(LTM) serving cell change”, or “(LTM) cell change”. In this context, changing a cell may include a change in the SpCell (e.g., PCell or PSCell) and a change in SCells of a cell group (e.g., addition, modification, release, etc. of one or more SCells).

In the present disclosure, the term “configuration” when used in the context of an “LTM candidate target cell” (or equivalent term) refers to a configuration that enables a UE to access, connect, and/or operate in such a cell and is provided to the UE in advance of LTM execution. The configuration may be an RRC message or one or more portions thereof (e.g., SpCellConfig IE, SCellConfig IE, etc.). Such a configuration (including content, structure, and/or format) may also be referred to as an “RRC model”. A UE may be provided with multiple target candidate configurations, each associated with a different LTM candidate target cell. For example, a DU serving a candidate target cell generates a configuration for each cell and sends them to the CU, which provides them to the UE.

In the present disclosure, the term “lower layer protocol” refers to a protocol layer in radio air interface protocol stack that is lower than (or below) the RRC layer, protocol, such as MAC or PHY. Likewise, the term “lower layer message” refers to a message of a lower layer protocol, such as MAC Control Element (CE) or PHY downlink control information (DCI). In the specific context of LTM, such a lower layer message may be referred to as a “cell switch command” or an “LTM cell switch command.”

Some embodiments include methods for a UE configured to communicate with a RAN node via a serving cell. The UE can receive from the RAN node a message (e.g., RRC message) including a configuration for a lower layer (e.g., beam) measurement. The configuration includes one or more events, triggers, and/or conditions (referred to generically as “conditions”) for initiating lower layer measurements on one or more candidate cells (e.g., for L1/L2 inter-cell mobility). The one or more conditions can be based on results of RRM or lower layer measurements performed on the serving cell and/or on results of RRM measurements performed on the candidate cells. When the UE detects the one or more conditions are fulfilled, the UE initiates lower layer measurements on the one or more candidate cells and reports the results of these lower layer measurements to the RAN node (e.g., in a measurement report based on a reporting configuration previously received from the RAN node).

In some embodiments, a UE capable of LTM initiates a supervision timer upon reception of an LTM cell switch command (e.g., MAC CE for LTM execution). The LTM cell switch command includes an indication of a candidate cell (e.g., configuration ID, or LTM reconfiguration ID, candidate cell ID, cell group config ID, associated with the candidate cell the network wants the UE to move to). Upon reception of the LTM cell switch command, the UE also transmits an UL message over a Physical Uplink Shared Channel (PUSCH) or over a Physical Uplink Control Channel (PUCCH) of the candidate cell (i.e., not a RA preamble as conventional).

Subsequently, in response to receiving a DL message via the candidate cell, the UE considers the LTM execution procedure successful, stops the supervision timer, and performs first actions in the candidate cell accordingly. On the other hand, when the supervision timer expires before the UE receives a DL message via the candidate cell, the UE considers the LTM cell switch procedure as having failed and perform second actions accordingly, such as initiating an RRC Re-establishment or selecting another candidate cell for performing an LTM cell switch.

In some variants, before the UE transmits the UL message over PUSCH or PUCCH of the candidate cell, the UE determines that it does not need to perform RA in the candidate cell.

In some variants, the DL message may correspond to a MAC CE that is not a RAR (as in conventional techniques), or may correspond to PDCCH information (e.g., DCI) addressed to the UE's identity in the candidate cell (e.g., C-RNTI provided in the candidate cell configuration).

In some embodiments, the UL message is a MAC CE that is sent in response to reception of the LTM cell switch command from the UE's source cell (i.e., the cell the UE considers as its SpCell before LTM cell switch). In some of these embodiments, the DL message may be one or more HARQ feedback messages relating to the UL CE. In other embodiments, the UL message is an RRCReconfigurationComplete message that is sent in response to the reception of the LTM cell switch command from the UE's source cell (i.e., the cell the UE considers as the SpCell before LTM cell switch). In some of these embodiments, the DL message may be one or more HARQ feedback messages relating to the RRCReconfiguration-Complete message. In some variants of these embodiments, the UE can consider the LTM cell switch successful and stop of the timer upon reception of some number of HARQ ACKs, or consider the LTM cell switch procedure failed in response to receiving some number of HARQ NACK(s).

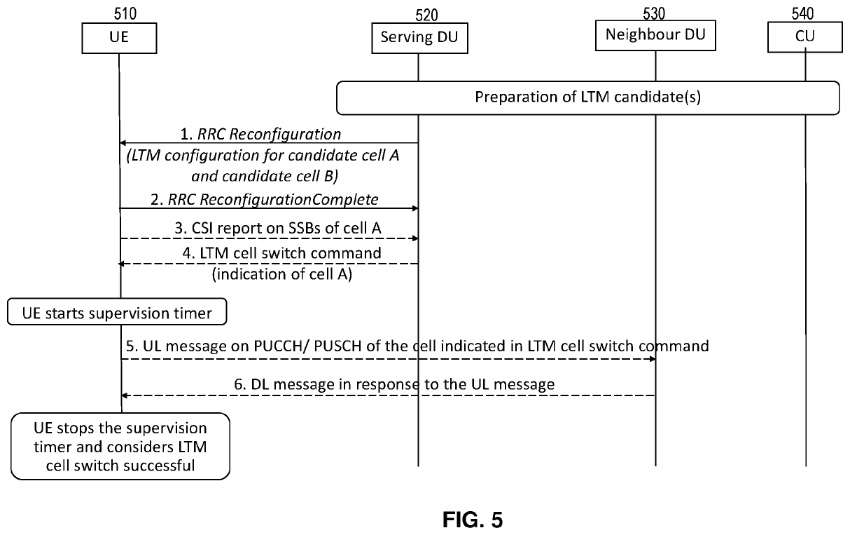

FIG. 5 is a signaling diagram that illustrates certain embodiments described above. The signaling shown in FIG. 5 is between a UE (510), a DU (520) that provides the UE's current serving cell (serving DU), a DU (530) that provides one or more neighbor cells (neighbor DU), and a CU (540) that controls the two DUs. Although some operations in FIG. 5 are given numerical labels, this is intended to facilitate explanation rather than to require or imply any particular operational order, unless expressly stated otherwise.

Initially, the CU, serving DU, and neighbor DU prepare two LTM candidate cells for the UE, namely cells A and B. In operation 1, the serving DU provides the configurations for LTM candidates A and B to the UE in an RRCReconfiguration message. In operation 2, the UE responds with an RRCReconfigurationComplete message. In operation 3, the UE sends a CSI report relating to SSBs of cell A. In operation 4, the serving DU sends to the UE an LTM cell switch command indicating cell A as a candidate target cell. In response, the UE starts the supervision timer and in operation 5, sends an UL message on PUCCH or PUSCH of cell A (indicated by the LTM cell switch command). In operation 6, the neighbor DU responds with a DL message, receipt of which causes the UE to stop the supervision timer and consider the LTM cell switch to cell A as being successful.

In other embodiments, a UE capable of LTM initiates a supervision timer upon reception of an LTM cell switch command (e.g., MAC CE for LTM execution). The LTM cell switch command includes an indication of a candidate cell (e.g., configuration ID, or LTM reconfiguration ID, candidate cell ID, cell group config ID, associated to the candidate cell the network wants the UE to move to). Upon reception of the LTM cell switch command, the UE starts to monitor a DL control channel in the indicated candidate cell (e.g., PDCCH). In response to detecting the DL message intended for the UE on the monitored DL control channel, the UE considers the LTM execution procedure successful, stops the supervision timer, and performs first actions in the candidate cell accordingly. On the other hand, when the supervision timer expires before the UE receives a DL message via the candidate cell, the UE considers the LTM cell switch procedure as having failed and perform second actions accordingly, such as initiating an RRC Re-establishment or selecting another candidate cell for performing an LTM cell switch.

Note that in these embodiments, the UE begins monitoring the DL control channel in response to the reception of the LTM cell switch command without first transmitting an UL message over PUSCH or PUCCH in the candidate cell. In such embodiments, in addition to indicating a candidate cell, the LTM cell switch command may indicate a TCI state and/or DL beam for the UE to monitor for the DL message. For example, the LTM cell switch command may include a TCI state ID, an SSB index (or similar identifier), a CSI-RS resource identifier, a beam indication or identifier, etc. for this purpose. In order to consider the LTM cell switch successful without transmitting an UL message, the UE must be already UL synchronized with the candidate cell.

In some variants, the DL message may correspond to a MAC CE that is not a RAR (as in conventional techniques), or may correspond to PDCCH information (e.g., DCI) addressed to the UE's identity in the candidate cell (e.g., C-RNTI provided in the candidate cell configuration).

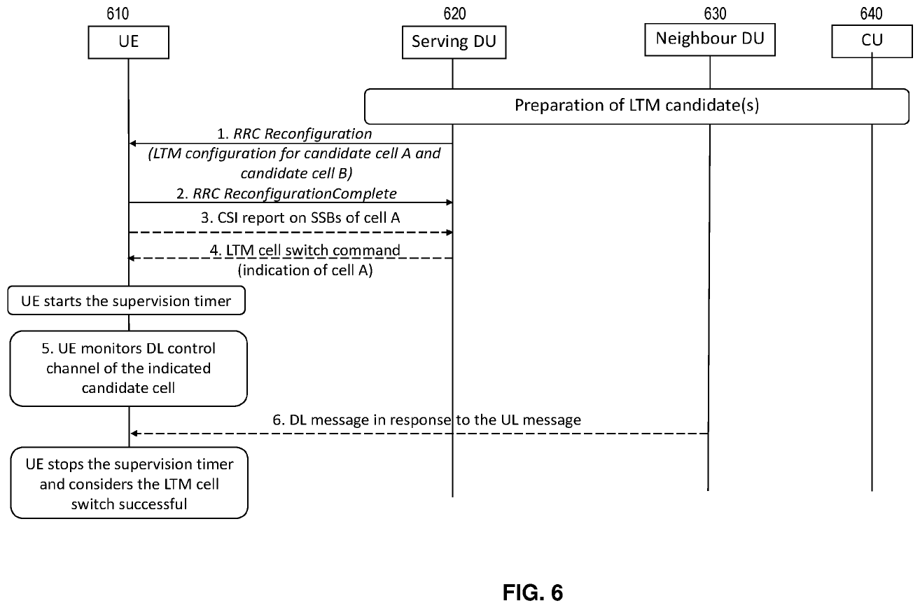

FIG. 6 is a signaling diagram that illustrates certain embodiments described above. The signaling shown in FIG. 6 is between a UE (610), a DU (620) that provides the UE's current serving cell (serving DU), a DU (630) that provides one or more neighbor cells (neighbor DU), and a CU (640) that controls the two DUs. Although some operations in FIG. 6 are given numerical labels, this is intended to facilitate explanation rather than to require or imply any particular operational order, unless expressly stated otherwise.

Initially, the CU, serving DU, and neighbor DU prepare two LTM candidate cells for the UE, namely cells A and B. In operation 1, the serving DU provides the configurations for LTM candidates A and B to the UE in an RRCReconfiguration message. In operation 2, the UE responds with an RRCReconfigurationComplete message. In operation 3, the UE sends a CSI report relating to SSBs of cell A. In operation 4, the serving DU sends to the UE an LTM cell switch command indicating cell A as a candidate target cell. In response, the UE starts the supervision timer and in operation 5 begins monitoring a DL control channel in cell A (indicated by the LTM cell switch command). In operation 6, the neighbor DU responds with a DL message in the monitored DL control channel, which upon receipt causes the UE to stop the supervision timer and consider the LTM cell switch to cell A as being successful.

In some embodiments, a UE capable of LTM selectively initiates a supervision timer upon reception of an LTM cell switch command (e.g., MAC CE for LTM execution). The LTM cell switch command includes an indication of a candidate cell (e.g., configuration ID, or LTM reconfiguration ID, candidate cell ID, cell group config ID, associated to the candidate cell the network wants the UE to move to). Upon reception of the LTM cell switch command, the UE also transmits an UL message over a Physical Uplink Shared Channel (PUSCH) or over a Physical Uplink Control Channel (PUCCH) of the candidate cell (i.e., not a RA preamble as conventional).

Selectively initiating the supervision timer may be based on whether a RA procedure is to be performed in the candidate cell indicated by the LTM cell switch. For example, the UE initiates the supervision timer when an RA procedure will be performed, and refrains from initiating the supervision timer when an RA procedure will not be performed (e.g., RACH-less). For example, the UE can initiate the supervision timer in response to the RA procedure determination, initiation of the RA procedure, or first transmission of a RA preamble during the RA procedure.

One advantage in using the supervision timer during a RA procedure is that while RA procedure is ongoing, the UE may not be able to perform RLM necessary for RLF detection and triggering subsequent UE actions such as connection re-establishment. On the other hand, when RA is not used, the UE may perform RLM in the target cell upon reception of the LTM cell switch command, which provides the UE with a mechanism for failure monitoring in the target cell thus eliminating the need for the supervision timer.

When the supervision timer is initiated based on an RA procedure in the candidate cell, the UE stops the supervision timer upon reception of RAR in the case of a CFRA, or upon reception of a message for contention resolution in the case of CBRA (e.g., MAC CE with a UE identity for contention resolution, received in response to a msg3 of the RA procedure). When a RA procedure is not used in the candidate cell, the UE starts RLM in the candidate cell upon reception of the LTM cell switch command. In some variants, the UE starts RLM in the candidate cell according to the candidate cell's RLM configuration but resets RLM/RLF related counters and timers (e.g., N310, N311, T310, T311, as defined in 3GPP TS 38.331). In other variants, the UE starts RLM in the candidate cell using the current values of some or all of these counters and timers, i.e., without resetting the values.

In other embodiments, a UE capable of LTM initiates a supervision timer upon reception of an LTM cell switch command (e.g., MAC CE for LTM execution). The LTM cell switch command includes an indication of a candidate cell (e.g., configuration ID, or LTM reconfiguration ID, candidate cell ID, cell group config ID, associated to the candidate cell the network wants the UE to move to). Upon reception of the LTM cell switch command, the UE transmits an UL message and selectively stops the supervision timer in response to receiving one of the following:
a DL message that is part of a RA procedure (e.g., RAR or a Contention Resolution MAC CE) that the UE initiated in the candidate cell);
a DL message that is not part of an RA procedure, in case the UE did not initiate a RA procedure in the candidate cell; or
a DL message that is associated with an RA procedure but not received in response to a RA preamble.

In some embodiments where the UE's UL message transmitted in the candidate target cell is a RA preamble in a Contention-Free RA (CFRA) procedure, the UE receives in response a RAR and stops the supervision timer, upon which the LTM cell switch procedure is considered successful. In some variants, the successful RAR reception may be determined by the UE's MAC layer entity based on the following:
a DL assignment has been received on the PDCCH for an RA-RNTI;
the received Transport Block (TB) is successfully decoded; and
the RAR contains a MAC subPDU with RA Preamble identifier corresponding to the transmitted RA preamble, matching the PREAMBLE_INDEX (as defined in clause 5.1.3 in TS 38.321).

In some variants, the UE considers the RA procedure successfully completed when the RAR reception in CFRA is considered successful, i.e., when the RA Preamble was not selected by the MAC entity among the contention-based RA Preambles.

In other variants, when the UE's MAC entity considers the RA procedure completed and the supervision timer is an RRC-layer timer (e.g., T304-like for LTM), the MAC entity indicates to a higher layer (e.g., RRC) that the RA procedure is successfully completed, which causes the higher layer to stop the supervision timer. In other variants, when the UE's MAC entity considers the RA procedure completed and the supervision timer is a MAC-layer timer, the UE MAC entity stops the supervision timer.

In some embodiments where the UE's UL message transmitted in the candidate target cell is a RA preamble in a Contention-Based RA (CBRA) procedure, the UE receives a responsive RAR, transmits a Msg3 (e.g., including the UE's C-RNTI in a C-RNTI MAC CE), and receives as the DL response a PDCCH transmission addressed to the UE's C-RNTI and containing an UL grant for a subsequent transmission. At this point, the UE considers the LTM execution successful and stops the supervision timer.

In some variants, when the RA preamble was selected by the MAC entity among the contention-based RA Preamble(s), the UE sets the temporary C-RNTI (to be included in msg3) to the temporary C-RNTI value received in the RAR. The UE indicates to its multiplexing and assembly entity to include a C-RNTI MAC CE in the subsequent UL transmission, obtains the MAC PDU to transmit from the multiplexing and assembly entity, and stores it in the Msg3 buffer. After the Msg3 is transmitted, the MAC entity at the UE monitors a PDCCH of the candidate cell, which is an SpCell in the activated BWP for LTM cell switch. When UE lower layers indicate reception of a PDCCH transmission in the candidate cell that is addressed to the C-RNTI in msg3 and contains a UL grant for a new transmission, the UE considers this RA procedure successfully completed based on successful contention resolution.

In some variants, when the UE's MAC entity considers the RA procedure completed and the supervision timer is an RRC-layer timer (e.g., T304-like for LTM), the MAC entity indicates to a higher layer (e.g., RRC) that the RA procedure is successfully completed, which causes the higher layer to stop the supervision timer. In other variants, when the UE's MAC entity considers the RA procedure completed and the supervision timer is a MAC-layer timer, the UE MAC entity stops the supervision timer.

In some embodiments where the UE's UL message transmitted in the candidate target cell is an UL message over PUSCH or PUCCH, the UE receives a DL message that is not part of a RA procedure, such as a PDCCH transmission addressed to the UE's identity in the candidate cell (e.g., C-RNTI) assigned by the network in the candidate cell configuration.

In some variants, the UE considers the LTM procedure successful upon notification from UE lower layers about reception of the PDCCH transmission addressed to the UE's identity in the candidate cell.

In other variants, the UE considers the LTM procedure successful upon notification from UE lower layers about reception of a PDCCH transmission that includes a MAC PDU containing a UE Contention Resolution Identity MAC CE that matches the UE's C-RNTI assigned by the network in the candidate cell configuration.

In other variants, the UE considers the LTM procedure successful upon notification from UE lower layers about reception of a PDCCH transmission that includes a MAC PDU containing a MAC CE that is responsive to the previously transmitted UL message.

In other variants, when the UE's MAC entity is configured for RACH-less LTM (i.e., no RA procedure), the UE considers the LTM procedure successful upon notification from the UE MAC entity about successful reception of a PDCCH transmission addressed to the UE's assigned C-RNTI and indicating a PDSCH transmission containing a UE Contention Resolution Identity MAC CE. Although the UE Contention Resolution Identity MAC CE typically includes a UE Contention Resolution Identity, when this MAC CE is received during RACH-less LTM the UE can ignore its contents.

In other variants, when the UE transmits an UL MAC CE in the candidate target cell in response to the reception of the LTM cell switch command from the UE's source cell, the UE considers the LTM procedure successful upon notification from the UE MAC entity about successful reception of at least one responsive DL message. In other variants, when the UE transmits an RRCReconfigurationComplete message in the candidate target cell in response to the reception of the LTM cell switch command from the UE's source cell, the UE considers the LTM procedure successful upon reception of at least one responsive DL message. For example, in the above variants, the UE may consider the procedure successful when it receives some number of HARQ ACKs, based on which the UE stops the supervision timer. On the other hand, the UE considers the LTM cell switch procedure failed in response to receiving some number of HARQ NACKs or not receiving some number of HARQ ACKs.

In different variants, when the UE's MAC entity considers the MAC layer procedure completed (e.g., RA procedure, reception of HARQ message(s), reception of a PDCCH transmission addressed to the UE's C-RNTI) and the supervision timer is an RRC timer (e.g., T304 for LTM), the MAC entity indicates to the RRC layer that the MAC procedure is successfully completed which cause the RRC layer to stop the supervision timer started upon LTM cell switch in RRC. When the supervision timer expires before the RRC layer receives such an indication from the MAC layer, the RRC layer considers the LTM cell switch procedure as having failed and initiates corresponding actions such as RRC Re-establishment.

In different variants, when the UE's MAC entity considers the MAC layer procedure completed (e.g., RA procedure, reception of HARQ message(s), reception of a PDCCH transmission addressed to the UE's C-RNTI) and the supervision timer is a MAC timer, the UE MAC entity considers the LTM cell switch successful and stops the supervision timer. In some cases, the MAC entity may indicate the successful LTM cell switch to the higher layers (e.g., RRC) which enables appropriate actions by higher layers. Similarly, when the MAC supervision timer expires, the UE MAC entity indicates the failure of LTM cell switch to the higher layers (e.g., RRC) which enables other appropriate actions by higher layers.

To summarize various embodiments described above, the UE may stop the supervision timer upon reception of a DL message part of the RA procedure, in case the UE performs RA during LTM cell switch. Alternately, the UE may stop the supervision timer upon reception of a DL message that is not part of a RA procedure, in case the UE does not perform RA during LTM cell switch. In some embodiments, the UE may determine that it does not need to perform random access in a candidate cell upon LTM cell switch based on one or more of the following:
LTM cell switch command received by the UE indicating a TCI state of the candidate cell, based on any of the ways discussed above. On the other hand, absence of the indication of a TCI state of the candidate cell in the LTM cell switch command received by the UE indicates that the UE needs to perform RA in the candidate cell.
Absence in the LTM cell switch command of an explicit indication to perform RA in the candidate cell.
Determining that the UE is time aligned or UL synchronized with the candidate cell, e.g., based on a time alignment (TA) timer for the candidate cell running in the UE.
RRC configuration of the candidate cell including an indication that there is no need for the UE to perform RA in the candidate cell upon LTM cell switch. Such an indication may be included when that candidate cell is UL synchronized with the UE's current PCell, PSCell, and/or SpCell.
Absence of a reconfigurationWithSync IE in the RRC configuration of the candidate cell, such that the UE is not configured with an initial value for the supervision timer and thus is unable to utilize the timer.

In various embodiments in which the UE does not perform RA in the candidate cell, the UL message transmitted by the UE in response to reception of the LTM cell switch command be one of the following: a MAC CE to the candidate cell indicating an LTM cell switch; an UL Scheduling Request (SR), or a PUCCH sequence.

In some embodiments, the UE receives an initial value to be used when starting the supervision timer for LTM cell switch to a candidate cell. The UE may receive that value as part of the configuration for the candidate cell, e.g., as part of a CellGroupConfig IE, the ReconfigurationWithSync IE, or another appropriate IE or field. an initial value to be used when UEs start supervision timers for LTM cell switch to a candidate cell may be set by the DU serving the candidate cell or by the CU controlling the DU. The former may be advantageous for MAC-layer supervision timers while the latter may be advantageous for RRC-layer supervision timers.

In some embodiments, the UE supervision timer for LTM cell switch is an instance of existing timer T304, which is also associated with a conventional reconfiguration with sync procedure. The initial value for such a supervision timer can be received in any of the forms discussed above, such as the in the CellGroupConfig IE.

In various embodiments, a supervision timer is considered to be a “X layer” timer when one or more of the following conditions are fulfilled:
the UE starts the timer at the X Layer entity;
the UE starts the timer in response to or as part of an X Layer procedure;
the UE starts a timer whose initial values are part of an X Layer configuration; and
the timer's UE behavior is specified in the protocol specification of X Layer.

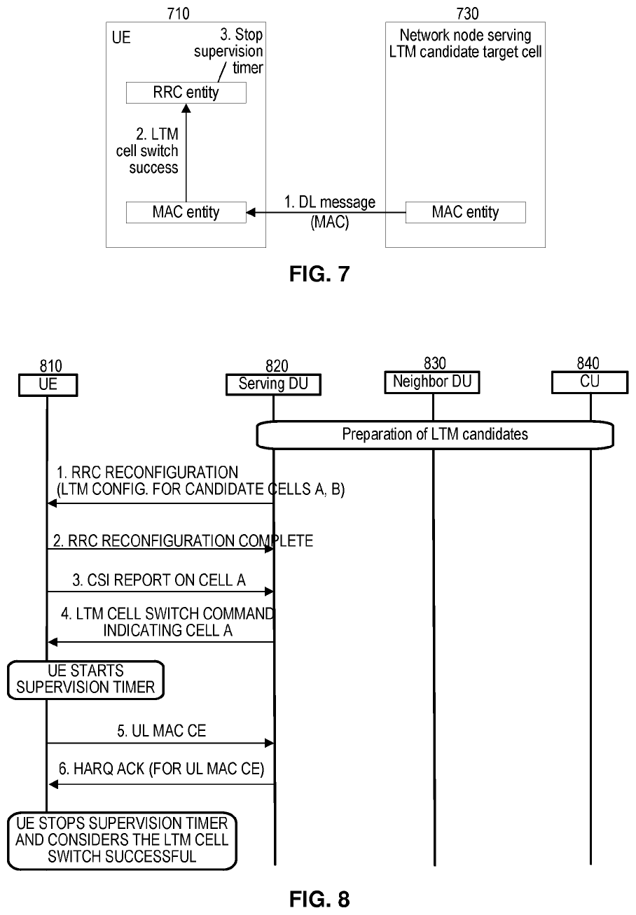

In some embodiments, the supervision timer is an RRC-layer timer. In such embodiments, when the UE receives an LTM cell switch command indicating a candidate cell, the UE switches to and/or applies the corresponding RRC configuration for the indicated candidate cell (i.e., that was previously received) and starts the RRC supervision timer. The MAC layer detects subsequent reception of the appropriate DL message (e.g., PDCCH reception addressed to the UE's C-RNTI) and also the resulting success of the LTM cell switch to the candidate cell. The MAC layer then indicates to RRC layer the success of the LTM cell switch and/or the reception of the DL message, which cause the RRC layer to stop the supervision timer. FIG. 7 shows an example inter-layer interaction in the UE (710) in response to receiving a MAC-layer DL message from the network node (730, e.g., DU) serving the candidate cell, according to these embodiments.

In other embodiments, the supervision timer may be a MAC-layer timer. In such embodiments, when the UE receives an LTM cell switch command indicating a candidate cell, the UE switches to and/or applies the corresponding RRC configuration for the indicated candidate cell (i.e., that was previously received) and starts the MAC supervision timer. The MAC layer detects subsequent reception of the appropriate DL message (e.g., PDCCH reception addressed to the UE's C-RNTI) and also the resulting success of the LTM cell switch to the candidate cell, causing the MAC layer to stop the supervision timer.

In other embodiments, the supervision timer may be a PHY-layer timer. In such embodiments, when the UE receives an LTM cell switch command indicating a candidate cell, the UE switches to and/or applies the corresponding RRC configuration for the indicated candidate cell (i.e., that was previously received) and starts the PHY supervision timer (e.g., when the PHY layer is notified of the LTM cell switch). The PHY layer detects subsequent reception of the appropriate DL message (e.g., PDCCH reception addressed to the UE's C-RNTI) and also the resulting success of the LTM cell switch to the candidate cell, causing the PHY layer to stop the supervision timer.

In some embodiments, upon considering the LTM execution successful and stopping the supervision timer, the UE starts RLM in the candidate cell. One benefit of starting RLM only after the successful LTM execution is that there is only one failure detection mechanism running at the time at the UE. The supervision timer is running while the UE tries to access the candidate cell indicated in the LTM cell switch command, and then RLM and its failure detection mechanism start only after LTM cell switch is successfully completed. Consequently, there is no risk of triggering a RLF due to OOS indications from UE PHY while the supervision timer is running. Moreover, the UE stops performing RLM when it receives an LTM cell switch command and only re-starts RLM when the LTM cell switch procedure is completed successfully.

In some embodiments, upon considering the LTM execution successful and stopping the supervision timer, the UE starts beam failure detection (BFD) monitoring with the candidate cell. One benefit of starting BFD only after the successful LTM execution is that there is only one failure detection mechanism running at the time at the UE. The supervision timer is running while the UE tries to access the candidate cell indicated in the LTM cell switch command, and then BFD and its failure detection mechanism start only after LTM cell switch is successfully completed. Consequently, there is no risk of triggering beam failure recovery (BFR) while the supervision timer is running; doing so would trigger a RA procedure in the candidate cell, which is undesirable. Moreover, the UE stops performing BFD related processes when it receives an LTM cell switch command and only re-starts BFD when the LTM cell switch procedure is completed successfully.

In some embodiments, upon considering the LTM execution to a candidate cell successful and stopping the supervision timer, the UE starts one or more of the following:
operating according to the candidate cell configuration; and
performing CSI measurement on other LTM candidate cells.

In some embodiments, when the supervision timer (e.g., T304) expires before the UE receives a DL message via the candidate cell, the UE considers the LTM cell switch procedure as failed and performs one or more of the following:
initiates an RRC Re-establishment procedure, including cell selection while timer T311 is running;
selects a different LTM candidate cell (i.e., configured at the UE before the failure was detected) for performing another LTM cell switch, also; and
logs/stores information related to the LTM failure to be possibly reported to the network at a later time.

In other embodiments, the UE performs RLM in the candidate cell while the supervision timer is running. In such case, while the supervision timer is running, the UE's lower layers may generate OOS indications to upper layers that increment corresponding counters (e.g., N310). In response to receiving the LTM cell switch command, the UE stops performing RLM on RLM-RS of the source cell and start performing RLM on different RLM-RS of the candidate cell, which may be part of the candidate cell configuration and/or part of TCI state information in the LTM cell switch command (or derived therefrom).

In some embodiments, when the UE RRC layer receives from UE PHY N310 consecutive OOS indications for the SpCell (e.g., PCell, SpCell in DC), the UE starts T310 for the SpCell and stops the supervision timer. This prevents occurrence of RLF while the supervision timer is running. After T310 is started, the UE performs appropriate actions while T310 is running.

In other embodiments, when the UE RRC layer receives from UE PHY N310 consecutive OOS indications for the SpCell (e.g., PCell, SpCell in DC), the UE starts T310 for the SpCell and keeps the supervision timer running. If T310 expires while the supervision timer is running, the UE declares RLF and performs appropriate actions such as initiation of RRC Re-establishment and stopping of the supervision timer. On the other hand, if the supervision timer expires while T310 is running, the UE considers the LTM procedure as failed and stops T310.

In some embodiments, the UE receives an initial value for a supervision timer (e.g., for T304-like timer), wherein the initial value may be associated with a specific LTM candidate cell or multiple LTM candidate cells. The UE starts the supervision timer using the initial value upon reception of an LTM cell switch command indicating an associated candidate cell (e.g., MAC CE for LTM execution). When the UE triggers a RA procedure to the candidate cell as part of LTM execution and the RA is successful (e.g., reception of CFRA RAR, reception of CBRA msg4), the UE stops the supervision timer. On the other hand, when the supervision timer expires before receiving such a message, the UE perform appropriate actions such as RRC re-establishment or selection of another candidate cell for LTM cell switch.

In cases where the UE does not perform RA during LTM execution to a candidate cell, the UE starts the supervision timer using the initial value upon reception of the LTM cell switch command and then performs other operations in the candidate cell such as reconfiguration with sync, transmission of a SR, transmission of a MAC CE, transmission of bits in the UL grants on PUSCH, etc. The UE stops the supervision timer upon reception of PDCCH addressed to its configured C-RNTI in the candidate cell, reception of HARQ ACK(s) for its UL MAC CE, etc.

In other embodiments, the UE selectively starts the supervision timer using the initial value upon reception of an LTM cell switch command, based on whether the UE needs to perform in the candidate cell as part of LTM execution. For example, the UE starts the supervision timer when the UE needs to perform RA and refrains from starting the supervision timer when the UE does not need to perform RA. In the latter case, when the UE receives the LTM cell switch command (e.g., MAC CE) including a TCI activation/beam indication, the UE starts RLM in the candidate cell.

In some variants, the UE starts RLM in candidate cell after resetting the RLM-related counters and timers (e.g., N310, T310, etc.) that were running in the UE's source cell before LTM. In other variants, the UE starts RLM in candidate cell using existing values (i.e., not reset) for one or more of the RLM-related counters and timers.

In other embodiments, the UE selectively starts the supervision timer using the initial value upon reception of an LTM cell switch command, based on presence, absence, or value of a field or IE in the configuration for the candidate cell (i.e., that was previously received). For example, the UE starts the supervision timer when a ReconfigurationWithSync IE is included in the candidate configuration. As another example, the UE starts the supervision timer when an initial value for the supervision timer (or indication to start the timer) is included in the candidate configuration but outside of a ReconfigurationWithSync IE.

In the above examples, the UE refrains from starting the supervision timer when the respective information is absent or explicitly indicates to not start the supervision timer. In a variant, if an initial value is present in the candidate cell configuration together with an indication to not start the supervision timer, the UE follows the indication rather than the presence of the initial value.

Some embodiments can be represented by text in 3GPP specifications. Below is some exemplary text for 3GPP TS 38.331 (RRC specification) and 38.321 (MAC specification) that represents certain embodiments. In this example, the UE RRC layer stops timer T304 for a cell group if running, when UE MAC entity indicates the successful reception of a PDCCH transmission addressed to the UE's C-RNTI for a procedure triggered due to LTM execution. The UE MAC entity indicates the successful reception of a PDCCH transmission addressed to the UE's C-RNTI responsive a UE UL message over PUSCH and/or PUCCH in the candidate cell, for a procedure triggered due to LTM execution.

### ***Begin 3GPP TS 38.331 Text***

### 5.3.5.3 Reception of an RRCReconfiguration by the UE

The UE shall perform the following actions upon reception of the RRCReconfiguration, or upon execution of the conditional reconfiguration (CHO, CPA, or CPC):

```
[...]
1>set the content of the RRCReconfigurationComplete message as follows:
[...]
1>if the UE is configured with E-UTRA nr-SecondaryCellGroupConfig (UE in (NG)EN-DC):
[...]
1>else if the RRCReconfiguration message was received via SRBI within the nr-SCG within
  mrdc-SecondaryCellGroup (UE in NR-DC, mrdc-SecondaryCellGroup was received in
  RRCReconfiguration or RRCResume via SRB1):
[...]
1>else if the RRCReconfiguration message was received via SRB3 (UE in NR-DC):
[...]
1>else (RRCReconfiguration was received via SRB1):
    [...]
```

1> if reconfigurationWithSync was included in spCellConfig of an MCG or SCG and when MAC of an NR cell group successfully completes a Random Access procedure triggered above; or,
1> if MAC indicates the successful reception of a PDCCH transmission addressed to C-RNTI and if the procedure is triggered due to LTM execution; or,

```
  1>if sl-PathSwitchConfig was included in reconfigurationWithSync included in spCellConfig
    of an MCG, and when successfully sending RRCReconfigurationComplete message (i.e.,
    PC5 RLC acknowledgement is received from target L2 U2N Relay UE):
    2>stop timer T304 for that cell group if running;
      [...]
***End 3GPP TS 38.331 text ***
***Begin 3GPP TS 38.321 text ***
...
    if the MAC entity is configured with LTM-RACH-less and a UE Contention Resolution
    Identity MAC control element for this TTI has been received on the PDSCH indicated by
    the PDCCH of the SpCell addressed to the C-RNTI; or
    if the MAC entity is configured with LTM-RACH-less and after transmitting an UL
    message the PDSCH indicated by the PDCCH of the SpCell addressed to the C-RNTI;
  - indicate to upper layer the successful reception of a PDCCH transmission addressed to the
    C-RNTI.
*** End 3GPP TS 38.321 text ***
```

In other embodiments, a UE capable of LTM receives an LTM candidate cell configuration and an LTM cell switch command that includes an indication of the candidate cell (e.g., configuration ID, or LTM reconfiguration ID, candidate cell ID, cell group config ID, etc.) associated with the configuration. The LTM cell switch command (e.g., MAC CE), may also include a TCI activation/beam indication. Upon reception of the LTM cell switch command, the UE starts RLM in the indicated candidate cell. If the UE is already performing RLM with the source cell when it receives the LTM cell switch command, the UE stops RLM with the source cell and starts RLM with the candidate cell. In such case, the UE may stop RLM-related timers (e.g., T310, T311) if running and/or reset RLM-related counters (e.g., N310 for OSS, N311 for IS) to zero or other initial value.

In such embodiments, the LTM cell switch procedure is considered successful when an RLF is not triggered “shortly after” reception of the LTM cell switch command. In other words, it is the absence of RLF within a short duration rather than reception of a DL message from the candidate cell that causes the UE to determine that the LTM procedure is successful. The short duration for the consideration of RLF can be pre-configured (e.g., by 3GPP specification), configured by the network (e.g., as part of candidate cell configuration), or specific to UE implementation.

In some embodiments, in response to reception of an LTM cell switch command (indicating a candidate cell), the UE starts a supervision timer and starts RLM in the indicated candidate cell. When RLF is not declared while the supervision timer is running, the LTM cell switch procedure is considered successful, and the UE perform actions accordingly (e.g., stops RLM timer T310 and supervision timer). When RLF declared while the supervision timer is running, the UE considers the LTM cell switch procedure as failed and performs appropriate actions such as stopping the supervision timer, initiation of an RRC Re-establishment procedure, reverting to the source cell configuration, and/or selection of a different candidate cell to perform another LTM execution procedure.

In other embodiments, when the UE starts a supervision timer and starts RLM in the indicated candidate cell in response to the reception of an LTM cell switch command, and RLM timer T310 does not expire while the supervision timer is running, the LTM cell switch procedure is considered successful and the UE perform actions accordingly (e.g., stops RLM timer T310 and supervision timer). When T310 expires while the supervision timer is running, the UE considers the LTM cell switch procedure as failed and performs appropriate actions such as stopping the supervision timer, initiation of an RRC Re-establishment procedure, reverting to the source cell configuration, and/or selection of a different candidate cell to perform another LTM execution procedure.

In other embodiments, when the UE starts a supervision timer and starts RLM in the indicated candidate cell in response to the reception of an LTM cell switch command, and no OOS indication is received from UE lower layers while the supervision timer is running (and/or N310 is set to 1 and timer T310 is not started), the LTM cell switch procedure is considered successful and the UE perform actions accordingly (e.g., stops RLM timer T310 and supervision timer). When at least one OOS indication is received from UE lower layers while the supervision timer is running, the UE considers the LTM cell switch procedure as failed and performs appropriate actions such as stopping the supervision timer, initiation of an RRC Re-establishment procedure, reverting to the source cell configuration, and/or selection of a different candidate cell to perform another LTM execution procedure.

In some variants of the above-described embodiments, the UE starts RLM upon reception of the LTM cell switch command only when RA procedure is not performed for the LTM cell switch.

In some embodiments, the UE does not start a supervision timer in response to reception of an LTM cell switch command but relies instead on RLM on the candidate cell as a failure detection mechanism. This can be beneficial when the LTM cell switch is a RACH-less procedure.

In a variant of these embodiments, in addition to starting RLM in the candidate cell, the UE may start a timer having a different purpose than the supervision timer discussed above, e.g., related to UE reporting for self-organizing network (SON) functionality. In such variants, when the timer expires and RLF has not been detected, the LTM execution procedure is considered successful. On the other hand, when RLF is detected while the timer is running and/or the timer expires (i.e., before any RLF is detected), the procedure is considered failed.

In other embodiments, a UE capable of LTM receives an LTM candidate cell configuration and an LTM cell switch command that includes an indication of the candidate cell (e.g., configuration ID, or LTM reconfiguration ID, candidate cell ID, cell group config ID, etc.)

associated with the configuration. The LTM cell switch command (e.g., MAC CE), may also include a TCI activation/beam indication. Upon reception of the LTM cell switch command, the UE sends an UL MAC CE to the candidate cell indicated in the LTM cell switch command. The UL MAC CE may be used to acknowledge to the network (e.g., DU controlling the candidate cell) that the LTM cell switch is being performed.

In some embodiments, the LTM cell switch procedure is considered successful upon occurrence of any of the following:
after successful completion of a RA procedure in the candidate cell (i.e., when initiated);
after sending a SR and receiving an UL grant from the network; and/or
receiving one or more HARQ ACKs to an UL message (e.g., UL MAC CE) transmitted by the UE, i.e., acknowledging successful reception at the network for the UL message.

For example, when the UE transmits an UL MAC CE to the candidate cell in response to an LTM cell switch command from the source cell, the UE expects to receive HARQ feedback message(s) for that transmitted UL MAC CE. When the UE receives HARQ ACK(s) the UE knows that the UL MAC CE was successfully received by the network, so that the UE considers the LTM cell switch procedure successful and stops a supervision timer, if initiated and running. When the supervision timer expires without the UE having received a HARQ ACK for the UL MAC CE, the LTM procedure is considered as failed.

In some embodiments, the UE considers the LTM cell switch procedure as failed after transmitting an UL message (e.g., UL MAC CE) and receiving some number (N) of HARQ NACKs indicating that the UL MAC CE has not been successfully received by the network. The number N may be pre-configured (e.g., in 3GPP specification), configured by the network (e.g., as part of candidate cell configuration), or set based on UE implementation.

In some embodiments, the UE considers the LTM cell switch procedure as failed after transmitting an UL message (e.g., UL MAC CE) and not receiving HARQ ACKs indicating that the UL MAC CE has been successfully received by the network (and/or not receiving HARQ

NACKs indicating unsuccessful reception). In case the UE started a supervision timer when it received the LTM cell switch command, the UE considers the LTM cell switch procedure as failed when the UE does not receive HARQ ACK/NACK(s) from the network while the supervision timer is running.

In some embodiments, a network node (e.g., gNB, CU, DU) serving an LTM candidate cell acknowledges the reception of the UL MAC CE transmitted by a UE during LTM execution. When the UL MAC CE is correctly received and decoded by the network, the network may send a HARQ ACK to the UE. In case the network is not able to decode the UL MAC CE transmitted by the UE, the network may take one of the following actions:
send a HARQ NACK to the UE;
send a request to the UE to retransmit the UL MAC CE (e.g., via DCI format 0_0/0_1 with NDI not toggled); or
refrain from sending a HARQ acknowledgment to the UE.

In some variants, a UE may interpret that the UL MAC CE has been correctly received by the network if no request for retransmission associated with the UL MAC CE is received by the UE.

In some embodiments, when the UE sends an UL MAC CE to the candidate cell indicated in the LTM cell switch command to acknowledge that the LTM cell switch is being performed, the UE may perform a RA procedure in the candidate cell. In these embodiments, the UL MAC CE may be included in an UL transmission during the RA procedure, e.g., in payload of msg3 following a RAR to the UE's RA preamble transmission.

In some embodiments, the supervision timer used during the execution of the LTM cell switch may be a MAC-entity timer. The LTM cell switch command may include an initial value of the supervision timer and/or an indication of whether to use the supervision timer during the LTM cell switch.

In some embodiments, the UE uses a supervision timer in the UE MAC entity to supervise the execution of the LTM cell switch and also counts HARQ NACKs received from the network in response to sending an UL MAC CE to the candidate cell. The LTM execution procedure is consider as failed either when either the supervision timer expires or N HARQ NACKs are received by the UE before the supervision timer expires.

In some embodiments, the UE uses a supervision timer in the UE MAC entity to supervise the execution of the LTM cell switch and also counts requests for retransmission (e.g., via the DCI 0_0/0_1 with NDI not toggled) received from the network in response to sending the UL MAC CE to the candidate cell. The LTM execution procedure is consider as failed either when either the supervision timer expires or K requests for retransmission are received by the UE before the supervision timer expires.

In some embodiments, values for at least one variable/counter (e.g., “N” or “K”) used by the UE to monitor the detection of an LTM cell switch failure are configured by the network (e.g., the CU, or the candidate DU, or the Serving DU) according to one or more of the following:
Within each LTM candidate cell configuration, such that each LTM candidate cell configuration has a dedicated set of variables/counters used by the UE to detect a possible failure of the LTM cell switch procedure;
Within the DL MAC CE used to trigger the execution of the LTM cell switch procedure, such that the set of variables/counters used by the UE to detect a possible failure of the LTM cell switch procedure can be specific to a certain LTM candidate cell or common to all the configured LTM candidate cells; and
Within cell-specific signaling such as a SIB and/or ServingCellConfigCommon IE (or parameters therein).

FIG. 8 shows a signaling diagram that illustrates certain embodiments described above. The signaling shown in FIG. 8 is between a UE (810), a DU (820) that provides the UE's current serving cell (serving DU), a DU (830) that provides one or more neighbor cells (neighbor DU), and a CU (840) that controls the two DUs. Although some operations in FIG. 8 are given numerical labels, this is intended to facilitate explanation rather than to require or imply any particular operational order, unless expressly stated otherwise.

Initially, the CU, serving DU, and neighbor DU prepare two LTM candidate cells for the UE, namely cells A and B. In operation 1, the serving DU provides the configurations for LTM candidates A and B to the UE in an RRCReconfiguration message. In operation 2, the UE responds with an RRCReconfigurationComplete message. In operation 3, the UE sends a CSI report relating to cell A. In operation 4, the serving DU sends to the UE an LTM cell switch command indicating cell A as a candidate target cell. In response, the UE starts the supervision timer and in operation 5 transmits an UL MAC CE to cell A (indicated by the LTM cell switch command). In operation 6, the neighbor DU responds with a HARQ ACK that confirms the successful reception of the UL MAC CE in cell A, which upon receipt causes the UE to stop the supervision timer and consider the LTM cell switch to cell A as being successful.

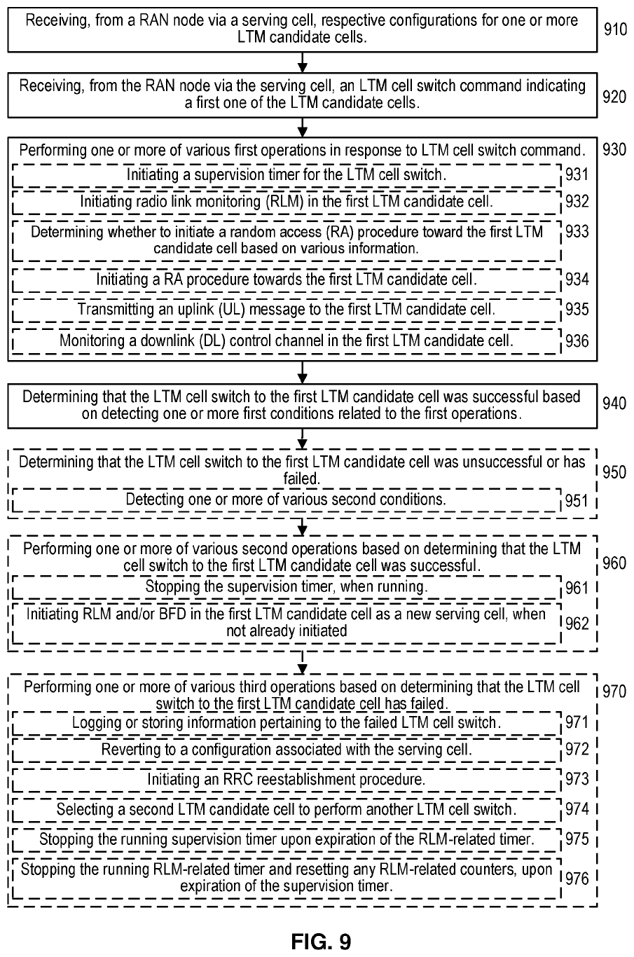

The embodiments described above can be further illustrated with reference to FIG. 9, which depicts an exemplary method (e.g., procedure) for a UE configured for L1/L2-triggered mobility (LTM) in a RAN, according to various embodiments of the present disclosure. Put differently, various features of the operations described below correspond to various embodiments described above. The exemplary method shown in FIG. 9 can be performed by a UE (e.g., wireless device) such as described elsewhere herein. Although the exemplary method is illustrated in FIG. 9 by specific blocks in a particular order, the operations corresponding to the blocks can be performed in different orders than shown and can be combined and/or divided into blocks and/or operations having different functionality than shown. Optional blocks or operations are indicated by dashed lines.

The exemplary method includes the operations of block 910, where the UE receives, from a RAN node via a serving cell, respective configurations for one or more LTM candidate cells. The exemplary method also includes the operations of block 920, where the UE receives, from the RAN node via the serving cell, an LTM cell switch command indicating a first one of the LTM candidate cells. The exemplary method can also include the operations of block 930, where the UE can perform one or more of the following first operations (labelled with corresponding sub-block numbers) in response to the LTM cell switch command:
initiating a supervision timer for the LTM cell switch,
initiating radio link monitoring (RLM) in the first LTM candidate cell,
initiating a random access (RA) procedure towards the first LTM candidate cell,
transmitting an UL message to the first LTM candidate cell, and
monitoring a DL control channel (e.g., PDCCH) in the first LTM candidate cell.

The exemplary method also includes the operations of block 940, where the UE determines that the LTM cell switch to the first LTM candidate cell was successful based on detecting one or more first conditions related to the first operations.

In some embodiments, the configuration for each LTM candidate cell include one or more of the following relating to LTM cell switch procedures to the LTM candidate cell:
an indication of whether to use a supervision timer;
an initial value for a supervision timer; and
an indication of whether a RA procedure is required.

In such embodiments, the first operations are performed in accordance with the configuration for the first LTM candidate cell.

In some embodiments, the exemplary method also includes the operations of block 960, where the UE performs one or more of the following second operations (labelled with corresponding sub-block numbers) based on determining in block 940 that the LTM cell switch to the first LTM candidate cell was successful:
(961) stopping the supervision timer, when running; and
(962) initiating RLM and/or beam failure detection (BFD) in the first LTM candidate cell as a new serving cell, when not already initiated.

In some of these embodiments, the first operations include initiating the supervision timer in sub-block 931 and initiating RLM in the first LTM candidate cell in sub-block 932, and the first conditions include one of the following while the supervision timer is running:
detecting no RLF based on the RLM;
receiving no OOS indications from UE lower layers based on the RLM; and
a running RLM-related timer does not expire.

In some variants of these embodiments, the exemplary method also includes the operations of block 970, where the UE performs one or more of the following third operations (labelled with corresponding sub-block numbers) based on determining in block 950 that the LTM cell switch to the first LTM candidate cell was unsuccessful or has failed:
(971) logging or storing information pertaining to the failed LTM cell switch;
(972) reverting to a configuration associated with the serving cell;
(973) initiating an RRC reestablishment procedure; and
(974) selecting a second one of the LTM candidate cells to perform another LTM cell switch.

In some further variants, determining that the LTM cell switch to the first LTM candidate cell was unsuccessful or has failed in block 950 is based on the operations of sub-block 951, where the UE detects one or more of the following second conditions related to the first operations:
expiration of an RLM-related timer while the supervision timer is running; and
expiration of the supervision timer while the RLM-related timer is running.

In such variants, the third operations in block 970 also include the following, labelled with corresponding sub-block numbers:
(975) stopping the running supervision timer upon expiration of the RLM-related timer; and
(976) stopping the running RLM-related timer and resetting any RLM-related counters, upon expiration of the supervision timer.

In other embodiments, the first operations include initiating the supervision timer in sub-block 931 and monitoring the DL control channel in sub-block 936. In some variants, the first operations do not include initiating the RA procedure in sub-block 934. In such embodiments and variants, the one or more first conditions include receiving, based on the monitoring in sub-block 936, one or more first DL messages before expiration of the supervision timer.

In some of these embodiments, the first operations also include transmitting the UL message in sub-block 935, with the one or more first DL messages being responsive to the UL message. In some variants of these embodiments, the one or more first DL messages include one or more hybrid ARQ (HARQ) acknowledgements (ACKs) associated with the UL message.

In some of these embodiments, the UL message is one of the following: an UL MAC CE, an UL scheduling request, a PUCCH sequence, or an RRCReconfigurationComplete message. In some variants of these embodiments, the UL message is a MAC CE and the one or more first DL messages include the following:
a message received via the monitored DL control channel, wherein the message is addressed to an identifier assigned to the UE in the first LTM candidate cell and indicates a subsequent DL shared channel message for the UE; and
the subsequent DL shared channel message, which includes a UE Contention Resolution Identity MAC CE.

In some of these embodiments, the exemplary method also includes the operations of block 950, where the UE determines that the LTM cell switch to the first LTM candidate cell was unsuccessful or has failed based on detecting in sub-block 951 any of the following second conditions related to the first operations:
receiving one or more second DL messages while the supervision timer is running; and
expiration of the supervision timer without receiving the one or more first DL messages.

In some variants of these embodiments, the one or more second DL messages include at least one of the following: one or more requests to retransmit the UL message, and one or more HARQ negative acknowledgements (NACKs) of the UL message.

In other embodiments, the first operations in block 930 also include the operations of sub-block 933, where the UE determines whether to initiate the RA procedure based on one or more of the following:
presence, absence, and/or value of a field or IE in the configuration for the first LTM candidate cell;
presence, absence, and/or value of a field or IE in the LTM cell switch command; and
whether the UE is time-aligned and/or UL synchronized with the first LTM candidate cell.

In such embodiments, the first operations include initiating the RA procedure in sub-block 934 selectively based on the determination whether to initiate in sub-block 933.

In some of these embodiments, when it is determined in sub-block 933 to initiate the RA procedure, one or more of the following applies:
the first operations include initiating the supervision timer in sub-block 931 but do not include initiating RLM in sub-block 932; and
the first operations include transmitting the UL message in sub-block 935d, which is performed as part of RA procedure.

In some variants of these embodiments, the one or more first conditions include receiving a DL message responsive to the UL message, before expiration of the supervision timer. Additionally, the UL message is a RA preamble and the DL message is one of the following: a RA response (RAR), or a DL control channel message that is addressed to an identifier assigned to the UE in the first LTM candidate cell and that includes an UL grant for a subsequent UE transmission.

In some embodiments, the supervision timer is associated with one of the following UE protocol layers: RRC, MAC, or physical (PHY/L1). In some embodiments, each of the LTM candidate cells is a candidate to be used by the UE as one of the following: SpCell, PCell, PSCell, and SCell.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

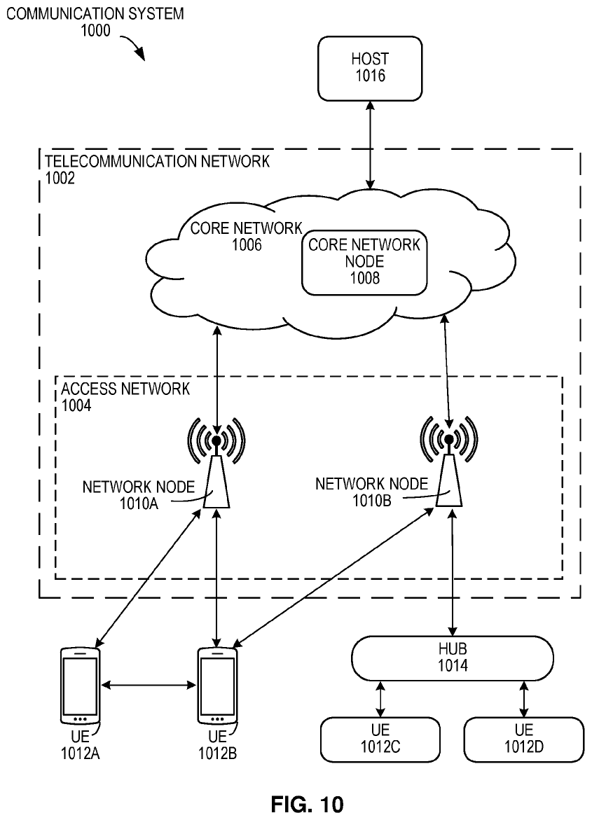

FIG. 10 shows an example of a communication system 1000 in accordance with some embodiments. In this example, communication system 1000 includes telecommunication network 1002 that includes access network 1004 (e.g., RAN) and a core network 1006, which includes one or more core network nodes 1008. Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1014 communicates with access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, in particular in if one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., UE 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub—that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

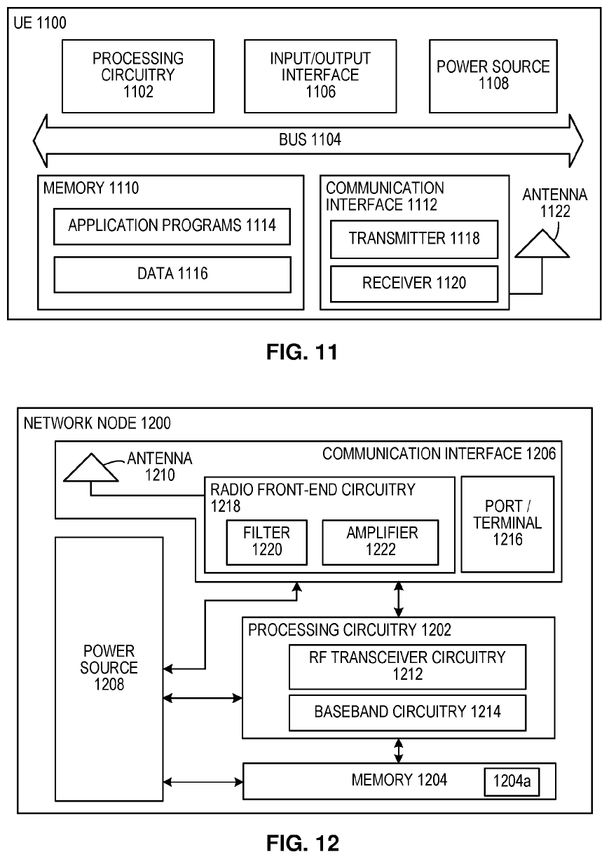

FIG. 11 shows a UE 1100 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via bus 1104 to input/output interface 1106, power source 1108, memory 1110, communication interface 1112, and possibly other components not explicitly shown. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to antenna 1122. Communication interface 1112 may include one or more transceivers used to communicate, such as by communicating with one or more remote transceivers of another device capable of wireless communication (e.g., another UE or a network node in an access network). Each transceiver may include transmitter 1118 and/or receiver 1120 appropriate to provide network communications (e.g., optical, electrical, frequency allocations, and so forth). Moreover, transmitter 1118 and receiver 1120 may be coupled to one or more antennas (e.g., 1122) and may share circuit components, software, or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes processing circuitry 1202, memory 1204, communication interface 1206, and power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes one or more of radio frequency (RF) transceiver circuitry 1212 and baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions (collectively denoted computer program product 1204a) capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with the baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

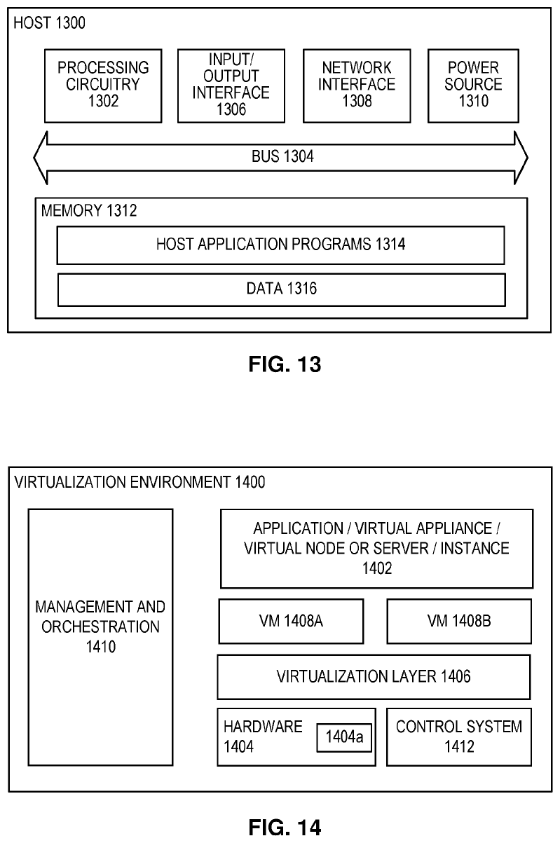

FIG. 13 is a block diagram of a host 1300, which may be an embodiment of host 1016 of FIG. 10, in accordance with various aspects described herein. Host 1300 may be or comprise various combinations hardware and/or software, including a standalone server, a blade server, a cloud-implemented server, a distributed server, a virtual machine, container, or processing resources in a server farm. Host 1300 may provide one or more services to one or more UEs.

Host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

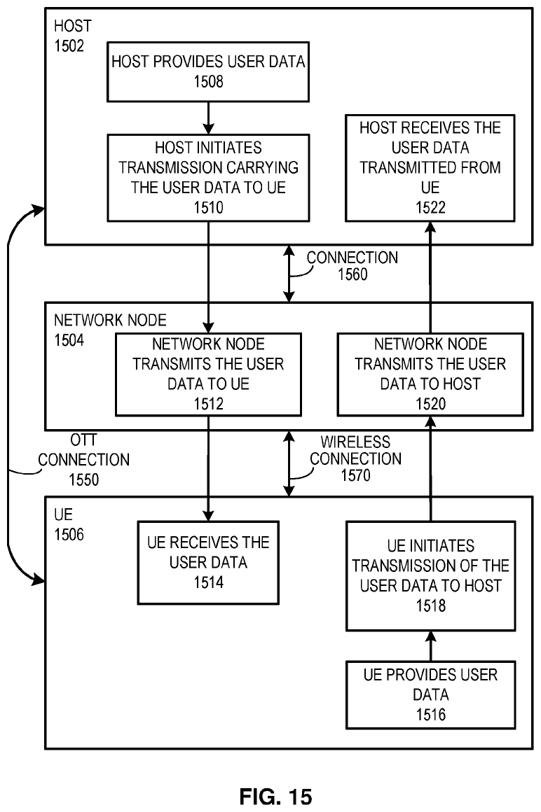

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1404 includes processing circuitry, memory that stores software and/or instructions (collectively denoted computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. The virtualization layer 1406 may present a virtual operating platform that appears like networking hardware to VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may differ. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each of VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of hardware 1404 and corresponds to application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of control system 1412 which may alternatively be used for communication between hardware nodes and radio units.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via a connection 1560 between host 1502 and network node 1504 and via wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. More precisely, embodiments can reduce and/or prevent undesired recovery actions by UEs. For example, due to the conditions for considering an LTM cell switch procedure successful (causing UE to stop a supervision timer), undesired recovery actions due to supervision timer expiration are prevented at the UE. This is especially an issue in the scenarios where LTM cell switch needs to be performed without a RA procedure (i.e., “RACH-less”). Preventing undesired recovery actions makes LTM RACH-less solutions more efficient, which reduces the delay to access an LTM candidate cell. Embodiments can facilitate predictable UE behavior in LTM execution failures and can reduce and/or eliminate ambiguity for UE actions in the event of LTM failures that are concurrent other failures such as radio link failure (RLF). By improving operation of UEs and RANs in this manner, embodiments increase the value of OTT services delivered to/from the UE via the RAN, to both end users and service providers.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. The reconfiguring of OTT connection 1550 may include message format, retransmission settings, preferred routing etc.; the reconfiguring need not directly alter the operation of network node 1504. Such procedures and functionalities may be known and practiced in the art. In certain embodiments, measurements may involve proprietary UE signaling that facilitates measurements of throughput, propagation times, latency, and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings, and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a user equipment (UE) configured for L1/L2-triggered mobility (LTM) in a radio access network (RAN), the method comprising:
receiving, from a RAN node via a serving cell, respective configurations for one or more LTM candidate cells;
receiving, from the RAN node via the serving cell, an LTM cell switch command indicating a first one of the LTM candidate cells;
performing one or more of the following first operations in response to the LTM cell switch command:
   initiating a supervision timer for the LTM cell switch,
   initiating radio link monitoring (RLM) in the first LTM candidate cell,
   initiating a random access (RA) procedure towards the first LTM candidate cell, and
   transmitting an UL message to the first LTM candidate cell; and
determining that the LTM cell switch to the first LTM candidate cell was successful based on detecting one or more first conditions related to the first operations; and
determining that the LTM cell switch to the first LTM candidate cell was unsuccessful or has failed based on detecting one or more second conditions related to the first operations.
   A2. The method of any of embodiments A1-A1d, wherein the configuration for each LTM candidate cell include one or more of the following relating to LTM cell switch procedures to the LTM candidate cell:
an indication of whether to use a supervision timer;
an initial value for a supervision timer; and
an indication of whether a RA procedure is required,
wherein the first operations are performed in accordance with the configuration for the first LTM candidate cell.
   A3. The method of any of embodiments A1-A2, further comprising performing one or more of the following second operations based on determining that the LTM cell switch to the first LTM candidate cell was successful:
stopping the supervision timer, if running; and
initiating RLM and/or beam failure detection (BFD) in the first LTM candidate cell as a new serving cell, if not already initiated.
   A3a. The method of any of embodiments A1-A3, further comprising performing one or more of the following third operations based on determining that the LTM cell switch to the first LTM candidate cell has failed:
logging or storing information pertaining to the failed LTM cell switch;
reverting to a configuration associated with the serving cell;
initiating a radio resource control (RRC) reestablishment procedure; and
selecting a second one of the LTM candidate cells to perform another LTM cell switch.
   A3b. The method of embodiment A3a, wherein:
the first operations include initiating the supervision timer and initiating RLM in the first LTM candidate cell; and
the first conditions include one of the following while the supervision timer is running: detecting no radio link failure (RLF) based on the RLM;
   receiving no out-of-sync (OOS) indications from UE lower layers based on the RLM; and
   a running RLM-related timer does not expire.
      A3c. The method of embodiment A3b, wherein:
the second conditions include the following:
   expiration of an RLM-related timer while the supervision timer is running; and
   expiration of the supervision timer while the RLM-related timer is running; and
the third operations also include the following:
   stopping the running supervision timer upon expiration of the RLM-related timer; and
   stopping the running RLM-related timer and resetting any RLM-related counters, upon expiration of the supervision timer.
      A4 The method of any of embodiments A1-A3, wherein:
the first operations include initiating the supervision timer without initiating the RA procedure; and
the one or more first conditions include receiving one or more first DL messages before expiration of the supervision timer.
   A4a. The method of embodiment A4, wherein the first operations also include transmitting the UL message, with the one or more first DL messages being responsive to the UL message.
   A4b. The method of any of embodiments A4-A4a, wherein the UL message is one of the following: an UL medium access control (MAC) control element (CE), an UL scheduling request, or a PUCCH sequence.
   A4c. The method of embodiment A4b, wherein the one or more second conditions include any of the following:
receiving one or more second DL messages while the supervision timer is running; and
expiration of the supervision timer without receiving the one or more first DL messages.
   A4d. The method of embodiment A4c, wherein:
the one or more first DL messages include respective hybrid ARQ (HARQ) acknowledgements (ACKs) of the UL MAC CE; and
the one or more second DL messages include at least one of the following:
   one or more requests to retransmit the UL MAC CE; and
   one or more HARQ negative acknowledgements (NACKs) of the UL MAC CE.
      A4e. The method of embodiment A4b, wherein:
the UL message is a medium access control (MAC) control element (CE);
the one or more first DL messages include:
   a PDCCH message that is addressed to an identifier assigned to the UE in the first LTM candidate cell and that indicates a subsequent PDSCH message for the UE; and
   the subsequent PDSCH message, which includes a UE Contention Resolution Identity MAC CE.
      A5. The method of any of embodiments A1-A3, wherein:
the first operations also include determining whether to initiate the RA procedure based on one or more of the following:
   presence, absence, and/or value of a field or information element (IE) in the configuration for the first LTM candidate cell;
   presence, absence, and/or value of a field or IE in the LTM cell switch command; and
   whether the UE is time-aligned and/or UL synchronized with the first LTM candidate cell; and
the first operations include initiating the RA procedure selectively based on the determination.
   A5a. The method of embodiment A5, wherein when it is determined to initiate the RA procedure, one or more of the following applies:
the first operations include initiating the supervision timer but do not include initiating RLM; and
the first operations include transmitting the UL message, which is performed as part of RA procedure.
   A5b. The method of embodiment A5a, wherein:
the one or more first conditions include receiving a DL message responsive to the UL message, before expiration of the supervision timer; and
the UL message is a RA preamble and the DL message is one of the following:
   a RA response (RAR), or
   a PDCCH message that is addressed to an identifier assigned to the UE in the first LTM candidate cell and that includes an UL grant for a subsequent UE transmission
      A6. The method of any of embodiments A1-A5b, wherein the supervision timer is associated with one of the following UE protocol layers: radio resource control (RRC), medium access control (MAC), or physical (PHY/L1).
      A7. The method of any of embodiments A1-A6, wherein each of the LTM candidate cells is a candidate to be used by the UE as one of the following: special cell (SpCell), primary cell (PCell), primary secondary cell group cell (PSCell), and secondary cell (SCell).
      B1. A user equipment (UE) configured for L1/L2-triggered mobility (LTM) in a radio access network (RAN), the UE comprising:
communication interface circuitry configured to communicate with the RAN node via at least one serving cell; and
processing circuitry operably coupled to the communication interface circuitry, wherein the processing circuitry and communication interface circuitry are further configured to perform operations corresponding to any of the methods of embodiments A1-A7.
   B2. A user equipment (UE) configured for L1/L2-triggered mobility (LTM) in a radio access network (RAN), the UE being further configured to perform operations corresponding to any of the methods of embodiments A1-A7.
   B3. A non-transitory, computer-readable medium storing computer-executable instructions that, when executed by processing circuitry of a user equipment (UE) configured for L1/L2-triggered mobility (LTM) in a radio access network (RAN), configure the UE to perform operations corresponding to any of the methods of embodiments A1-A7.
   B4. A computer program product comprising computer-executable instructions that, when executed by processing circuitry of a user equipment (UE) configured for L1/L2-triggered mobility (LTM) in a radio access network (RAN), configure the UE to perform operations corresponding to any of the methods of embodiments A1-A7.

1.-25. (canceled)

26. A method for a user equipment (UE) configured for layer-1/layer-2 triggered mobility (LTM) in a radio access network (RAN), the method comprising:
receiving the following from a RAN node via a serving cell:
respective configurations for one or more LTM candidate cells, and
an LTM cell switch command indicating a first one of the LTM candidate cells;
performing one or more of the following first operations in response to the LTM cell switch command:
initiating a supervision timer for the LTM cell switch,
initiating radio link monitoring (RLM) in the first LTM candidate cell,
initiating a random access (RA) procedure towards the first LTM candidate cell,
transmitting an uplink (UL) message to the first LTM candidate cell, and
monitoring a downlink (DL) control channel in the first LTM candidate cell; and
determining that the LTM cell switch to the first LTM candidate cell was successful based on detecting one or more first conditions related to the one or more first operations.

27. The method of claim 26, wherein the configuration for each LTM candidate cell include one or more of the following relating to LTM cell switch procedures to the LTM candidate cell:
an indication of whether to use a supervision timer;
an initial value for a supervision timer; and
an indication of whether a RA procedure is required,
wherein the first operations are performed in accordance with the configuration for the first LTM candidate cell.

28. The method of claim 26, further comprising performing one or more of the following second operations based on determining that the LTM cell switch to the first LTM candidate cell was successful:
stopping the supervision timer, when running; and
initiating RLM and/or beam failure detection (BFD) in the first LTM candidate cell as a new serving cell, when not already initiated.

29. The method of claim 26, wherein:
the first operations include initiating the supervision timer and initiating RLM in the first LTM candidate cell; and
the first conditions include one of the following while the supervision timer is running:
no radio link failure (RLF) is detected based on the RLM;
no out-of-sync (OOS) indications are received from UE lower layers based on the RLM; and
a running RLM-related timer does not expire.

30. The method of claim 29, further comprising performing one or more of the following third operations based on determining that the LTM cell switch to the first LTM candidate cell was unsuccessful or has failed:
logging or storing information pertaining to the failed LTM cell switch;
reverting to a configuration associated with the serving cell;
initiating a radio resource control (RRC) reestablishment procedure; and
selecting a second one of the LTM candidate cells to perform another LTM cell switch.

31. The method of claim 30, wherein:
determining that the LTM cell switch to the first LTM candidate cell was unsuccessful or has failed comprises detecting one or more of the following second conditions related to the first operations:
expiration of an RLM-related timer while the supervision timer is running, and
expiration of the supervision timer while the RLM-related timer is running; and
the third operations also include the following:
stopping the running supervision timer upon expiration of the RLM-related timer; and
stopping the running RLM-related timer and resetting any RLM-related counters, upon expiration of the supervision timer.

32. The method of claim 26, wherein:
the first operations include initiating the supervision timer and monitoring the DL control channel;
the first operations do not include initiating the RA procedure; and
the one or more first conditions include that one or more first DL messages are received, before expiration of the supervision timer, based on monitoring the DL channel.

33. The method of claim 32, wherein:
the first operations also include transmitting the UL message, with the one or more first DL messages being responsive to the UL message; and
the one or more first DL messages include one or more hybrid ARQ acknowledgements associated with the UL message.

34. The method of claim 33, further comprising determining that the LTM cell switch to the first LTM candidate cell was unsuccessful or has failed based on detecting any of the following second conditions related to the first operations:
receiving one or more second DL messages while the supervision timer is running; and
expiration of the supervision timer without receiving the one or more first DL messages.

35. The method of claim 34, wherein the one or more second DL messages include at least one of the following:
one or more requests to retransmit the UL message; and
one or more HARQ negative acknowledgements associated with the UL message.

36. The method of claim 32, wherein the UL message is one of the following: a medium access control (MAC) control element (CE), an UL scheduling request, a physical UL control channel (PUCCH) sequence, or an RRCReconfigurationComplete message.

37. The method of claim 32, wherein the UL message is a medium access control (MAC) control element (CE) and the one or more first DL messages include:
a message received via the monitored DL control channel, wherein the message is addressed to an identifier assigned to the UE in the first LTM candidate cell and indicates a subsequent DL shared channel message for the UE; and
the subsequent DL shared channel message, which includes a UE Contention Resolution Identity MAC CE.

38. The method of claim 26, wherein:
the first operations also include determining whether to initiate the RA procedure based on one or more of the following:
presence, absence, and/or value of a field or information element (IE) in the configuration for the first LTM candidate cell;
presence, absence, and/or value of a field or IE in the LTM cell switch command; and
whether the UE is time-aligned and/or UL synchronized with the first LTM candidate cell; and
the first operations include initiating the RA procedure selectively based on the determination whether to initiate.

39. The method of claim 38, wherein when it is determined to initiate the RA procedure, one or more of the following applies:
the first operations include initiating the supervision timer but do not include initiating RLM; and
the first operations include transmitting the UL message, which is performed as part of RA procedure.

40. The method of claim 39, wherein:
the one or more first conditions include receiving a DL message responsive to the UL message, before expiration of the supervision timer; and
the UL message is a RA preamble and the DL message is one of the following:
a RA response, or
a DL control channel message that is addressed to an identifier assigned to the UE in the first LTM candidate cell and that includes an UL grant for a subsequent UE transmission.

41. The method of claim 26, wherein the supervision timer is associated with one of the following UE protocol layers: radio resource control (RRC), medium access control (MAC), or physical (PHY/L1).

42. User equipment (UE) configured for layer-1/layer-2 triggered mobility (LTM) in a radio access network (RAN), the UE comprising:
communication interface circuitry configured to communicate with a RAN node via at least one serving cell; and
processing circuitry operably coupled to the communication interface circuitry, wherein the processing circuitry and communication interface circuitry are configured to:
receive the following from the RAN node via the serving cell:
respective configurations for one or more LTM candidate cells, and
an LTM cell switch command indicating a first one of the LTM candidate cells;
perform one or more of the following first operations in response to the LTM cell switch command:
initiate a supervision timer for the LTM cell switch,
initiate radio link monitoring (RLM) in the first LTM candidate cell,
initiate a random access (RA) procedure towards the first LTM candidate cell,
transmit an uplink (UL) message to the first LTM candidate cell, and
monitor a downlink (DL) control channel in the first LTM candidate cell; and
determine that the LTM cell switch to the first LTM candidate cell was successful based on detecting one or more first conditions related to the one or more first operations.

43. The UE of claim 42, wherein:
the first operations include initiate the supervision timer and initiate RLM in the first LTM candidate cell; and
the first conditions include one of the following while the supervision timer is running:
no radio link failure (RLF) is detected based on the RLM;
no out-of-sync (OOS) indications are received from UE lower layers based on the RLM; and
a running RLM-related timer does not expire.

44. The UE of claim 42, wherein:
the first operations include initiate the supervision timer and monitor the DL control channel;
the first operations do not include initiating the RA procedure; and
the one or more first conditions include that one or more first DL messages are received, before expiration of the supervision timer, based on monitoring the DL channel.

45. The UE of claim 42, wherein:
the first operations also include determine whether to initiate the RA procedure based on one or more of the following:
presence, absence, and/or value of a field or information element, IE, in the configuration for the first LTM candidate cell;
presence, absence, and/or value of a field or IE in the LTM cell switch command; and
whether the UE is time-aligned and/or UL synchronized with the first LTM candidate cell; and
the first operations include initiate the RA procedure selectively based on the determination whether to initiate.
